(19) United States
(12) Patent Application Publication
(10) Pub. No.: US 2022/0374872 A1
(43) Pub. Date: Nov. 24, 2022

(54) Platform for building decentralized applications

(71) Applicant: one37 Solutions Inc., Etobicoke (CA)

(72) Inventors: Fadwa Mohanna, Etobicoke (CA); Issa Chini, Etobicoke (CA)

(21) Appl. No.: 17/659,406

(22) Filed: Apr. 15, 2022

Related U.S. Application Data
(60) Provisional application No. 63/175,884, filed on Apr. 16, 2021.

(51) Int. Cl. G06Q 20/36

(52) U.S. Cl. CPC G06Q 20/3674; G06Q 2220/00

(57) ABSTRACT

An example system can include: at least one processor; and non-transitory computer-readable storage storing instructions that, when executed by the at least one processor, cause the system to: provide a workflow to add a verifiable credential on a client device, the workflow generating the verifiable credential according to parameters defined by an entity associated with the verifiable credential; populate the verifiable credential in a wallet on the client device, the wallet; and surface the verifiable credential from within the wallet when a request for the verifiable credential is received.

### RELATED APPLICATION(S)

This patent application is related to U.S. Patent Application No. 63/175,884 filed on Apr. 16, 2021, the entirety of which is hereby incorporated by reference.

### BACKGROUND

Maintaining control over one's data has become of great importance due to continuous data breaches. As a consequence, trust in exchanged data between entities has eroded; the trust in the integrity of the data and the trust in the identity of sending or receiving entities. Leveraging cryptography to reestablish the authenticity and integrity of the data is not enough, as data would typically still be tied to a particular platform and managed centrally, giving the data's owner less control and flexibility.

### SUMMARY

Embodiments of the disclosure are directed to a decentralized application platform.

In one aspect, an example system can include: at least one processor; and non-transitory computer-readable storage storing instructions that, when executed by the at least one processor, cause the system to: provide a workflow to add a verifiable credential on a client device, the workflow generating the verifiable credential according to parameters defined by an entity associated with the verifiable credential; populate the verifiable credential in a wallet on the client device, the wallet; and surface the verifiable credential from within the wallet when a request for the verifiable credential is received.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example decentralized application platform.

FIG. 2 shows an example process for zero knowledge proofs implemented by the platform of FIG. 1.

FIGS. 3A and 3B show example blocks used to build workflows implemented by the platform of FIG. 1.

FIGS. 4A and 4B shows example renderings of the blocks of FIGS. 3A and 3B.

FIG. 5 shows an example process of requesting a Zero Knowledge Proof workflow implemented by the platform of FIG. 1.

FIG. 6 shows an example process of managing of workflows implemented by the platform of FIG. 1.

FIG. 7 shows another example process of managing workflows implemented by the platform of FIG. 1.

FIG. 8 shows an example process of initiating a workflow from a wallet implemented by the platform of FIG. 1.

FIG. 9 shows an example process of managing verifiable credentials user interface templates implemented by the platform of FIG. 1.

FIG. 10 shows an example lifecycle of workflows implemented by the platform of FIG. 1.

FIG. 11 shows an example process of triggering cascaded workflows implemented by the platform of FIG. 1.

FIG. 12 shows an example user interface for a wallet implemented by the platform of FIG. 1.

FIG. 13 shows an example user interface for contacts in the wallet of FIG. 12.

FIG. 14 shows an example user interface for verifiable credentials in the wallet of FIG. 12.

FIG. 15 shows another example user interface for verifiable credentials in the wallet of FIG. 12.

FIG. 16 shows an example user interface for adding credentials implemented by the platform of FIG. 1.

FIG. 17 shows an example process for registering a static contact info alias implemented by the platform of FIG. 1.

FIG. 18 shows an example process for registering a static custom alias implemented by the platform of FIG. 1.

FIG. 19 shows an example process for resolving a static alias implemented by the platform of FIG. 1.

FIG. 20 shows an example process for registering of a seed implemented by the platform of FIG. 1.

FIG. 21 shows an example process for remote authentication with dynamic alias implemented by the platform of FIG. 1.

FIG. 22 shows an example process for registering a temporary alias implemented by the platform of FIG. 1.

FIG. 23 shows an example process for resolving a temporary alias implemented by the platform of FIG. 1.

FIG. 24 shows an example process for creating a new group implemented by the platform of FIG. 1.

FIG. 25 shows an example process for adding a new member to a group implemented by the platform of FIG. 1.

FIG. 26 shows an example process for resolving a group temporary alias implemented by the platform of FIG. 1.

FIG. 27 shows an example user interface for auto-consent options implemented by the platform of FIG. 1.

FIG. 28 shows an example process for obtaining a digital identification card verifiable credential implemented by the platform of FIG. 1.

FIG. 29 shows an example process for obtaining an authorization credential implemented by the platform of FIG. 1.

FIG. 30 shows an example process for using an authorization credential implemented by the platform of FIG. 1.

FIG. 31 shows an example dependency tree for credentials implemented by the platform of FIG. 1.

FIG. 32 shows another example dependency tree for credentials implemented by the platform of FIG. 1.

FIG. 33 shows another example dependency tree for credentials implemented by the platform of FIG. 1.

FIG. 34 shows an example process for autonomous backup of a wallet implemented by the platform of FIG. 1.

FIG. 35 shows an example process for restoring an autonomous backup of a wallet implemented by the platform of FIG. 1.

FIG. 36 shows an example process for using an air-gapped system for custodial backup implemented by the platform of FIG. 1.

FIG. 37 shows an example process or using an air-gapped system to restore a backed up wallet implemented by the platform of FIG. 1.

FIG. 38 shows an example process for securing communications implemented by the platform of FIG. 1.

FIG. 39 shows an example process for injecting verified metadata to secure communications implemented by the platform of FIG. 1.

FIG. 40 shows an example process for injecting an alias to secure communications implemented by the platform of FIG. 1.

### DETAILED DESCRIPTION

Embodiments of the disclosure are directed to a decentralized application platform.

In order to support the development of the platform, there is a need for enterprises, businesses, people and service providers to experiment with a new breed of digital wallets that retain trusted and verified data known as Verifiable Credentials (VCs)—a digital movement that allows an individual to own and control their data. VCs allows interaction in the digital world with the same freedom and capacity for trust as they do in the offline or physical world.

The example platform 100 described herein is a high performance, enterprise grade suite of decentralized application services that can be experience and customer-centric. It can be characterized by one or more of the following elements:

Fully compliant with the Pan-Canadian Trust Framework (PCTF) and the NIST 800-63 guidelines;

Privacy-by-design;

Distributed ledger enables trust in the network;

User consent-driven;

Easy to integrate with Partners (Issuers and Verifiers); and

Scalable with Assurance levels.

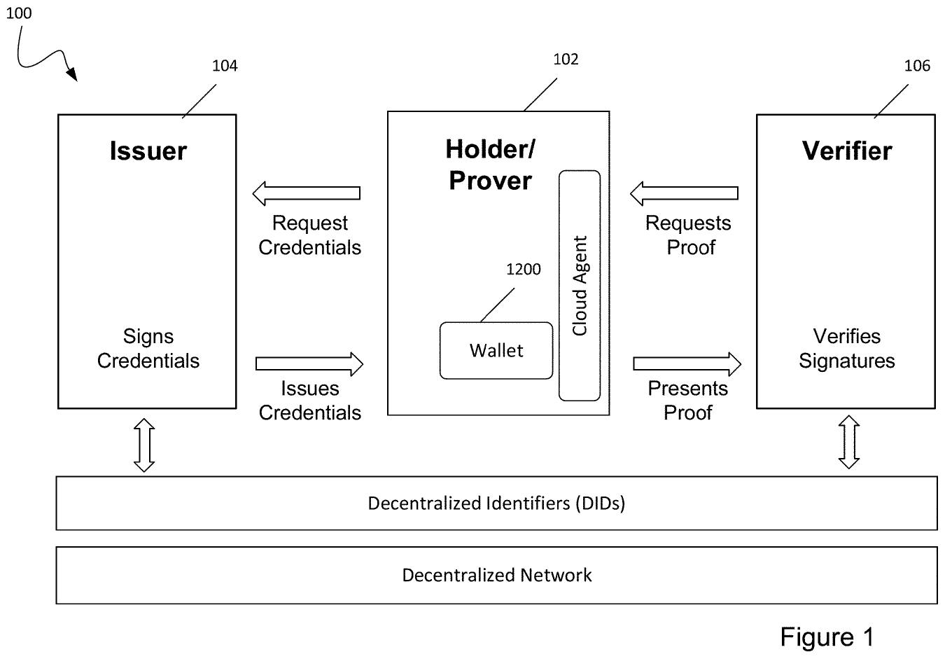

The platform 100 engages the following personas, as shown in FIG. 1:

Holder 102 of the verifiable credentials digital wallet;

Issuer of credentials 104; and

Verifier of Credentials 106.

The platform 100 can be characterized by one or more of the following features:

Information is decentralized: user information stored on their devices (encrypted);

Information sharing is controlled by a user under a consent-based exchange model;

Communication is point-to-point, preventing third party access to data (such as IdP);

Data transport uses encryption with destination key (confidentiality);

Data transport uses digital signing, guaranteeing integrity and source authenticity;

User endpoints are discovered through references from Blockchain;

User endpoints can selectively respond to queries upon verifying identity of remote party;

Cloud agent proxying wallet (device), preventing access to device information such as IP or other sensitive info; and

Use of zero-knowledge proofs to eliminate excess data collection.

Aspects of the platform 100 can be tied together under an experience instead of having one transaction at a time. Key considerations are made for system performance, scalability, and so on, as well as providing administrative capabilities to the various operators of the system.

Operation Dashboard

The operation dashboard handles the health check of the system performance and scalability and will provide a metric on a total number of transactions, any failures, any rejections, any queued messages. Due to the active messaging system, information associated with the dashboard can be completely confidential and encrypted.

Partner Portal

The partner module comprises a configuration management system with its underlying workflow and messaging engine along with a ticketing system to make it convenient for business users by providing them with a set of management tools. The workflow and the messaging engine, with their necessary configuration, assists in their processes of data fetching and pushing.

It also gives a way for the partners to customize the experience for the user akin to their brand and render relevant information to users on their devices as and when required.

The example platform 100 is programmed to implement the various processes described below. The platform is further programmed to implement any other processes described in U.S. Patent Application No. 63/175,884.

In these examples, the platform 100 is implemented as one or more computing devices. These computing devices can include clients and servers in communication with one another.

One example computing device includes a display, a processor, and memory. The display is a visual display, such as a screen, that illustrates various aspects associated with the computing device, such as one or more graphical user interfaces.

The system memory includes a random access memory (“RAM”) and a read-only memory (“ROM”). A basic input/output system that contains the basic routines that help to transfer information between elements within the computing device, such as during startup, is stored in the ROM. The computing device further includes a mass storage device. The mass storage device is able to store software instructions and data.

The mass storage device and its associated computer-readable data storage media provide non-volatile, non-transitory storage for the computing device. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing device.

According to various embodiments, the computing device may operate in a networked environment using logical connections to remote network devices through the network, such as a wireless network, the Internet, or another type of network. The computing device also includes an input/output controller for receiving and processing input from a number of other devices, including a touch user interface display screen, or another type of input device. Similarly, the input/output controller may provide output to a touch user interface display screen or other type of output device.

As mentioned above, the mass storage device and the RAM of the computing device can store software instructions and data. The software instructions include an operating system suitable for controlling the operation of the computing device. The mass storage device and/or the RAM also store software instructions, that when executed by the CPU, cause the computing device to provide the functionality of the computing device discussed in this document.

The example graphical user interfaces are illustrated by the figures filed herewith. These interfaces illustrate the various functionality associated with the platform, such as the functionality provided by the computing device. Various other configurations for the computing device and/or the interfaces are possible.

Aspects of the platform 100 focus on decentralized applications in order to offer a contactless user's experience, maintain sovereignty over one's data, and data integrity and authenticity, while enhancing experience, security and speed. This can include, without limitation: support for one or more identities within a wallet; custom attributes in DID schemas; and/or trust dependency of credentials.

In some aspects, the platform 100 includes one or more modules programmed to provide workflows that allow for the creation, editing, and removal of VCs. Such workflows can be performed locally within the wallet and/or include communication between the wallet and one or more third parties, such as a server and/or issuer of the VCs.

Further, the platform 100 can be programmed to provide an alias resolution service that is programmed to provide user-friendly references to the wallet. Such aliases can be static or dynamic and be managed through a centralized service to assure uniqueness.

In addition, the VCs can be extended to be used for authentication purposes in some implementations. In these examples, the platform 100 provides a workflow that can be used to convert a VC into an authentication credential. This authentication credential can, in turn, be used in place of typical authentication mechanisms, such as a username and password combination. The authentication credential can also include a deterministic identifier that allows for establishment of persistent ownership.

In addition to issuing and maintaining VCs, the example platform 100 can provide backup and restoration of wallets holding the VCs. In such examples, the backup can be secured by various mechanisms, such as encryption and/or by a custodian. Such backups can be semi- or full-automated.

Further, the wallet can be used to secure phone communications. As provided herein, upon establishing a telephone connection, additional metadata can be injected in the header of the call, such as an alias, and also to possibly sign the header with the digital wallet unique private key.

Additional details about example implementations of the platform 100 are provided below.

Overview of Workflow Services

Business processes typically require various data points. Therefore, in most cases, having one data element at a time is not considered on its own useful enough. Instead, data can flow through various processes, where additional data is required and new data is often created.

These processes are typically processes that implement various functions for a business and are sometimes referred to as business logic. The implementation itself may be done through workflows. These workflows may run on the backend services, in the digital wallet, or in both.

Verifiable Credentials

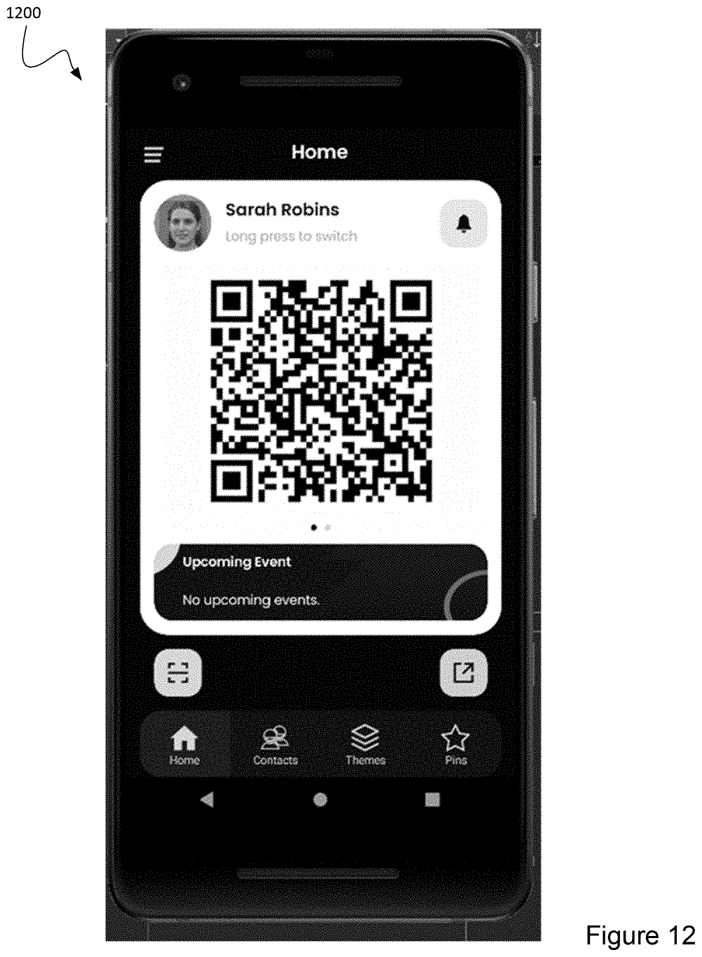

Verifiable Credentials (VCs) are the most granular level of data that is stored in a digital wallet, such as the example digital wallet 1200 shown in FIGS. 1 and 12. VCs are issued by an entity (often referred to as agency) and are signed using its corresponding private key to preserve their authenticity and integrity.

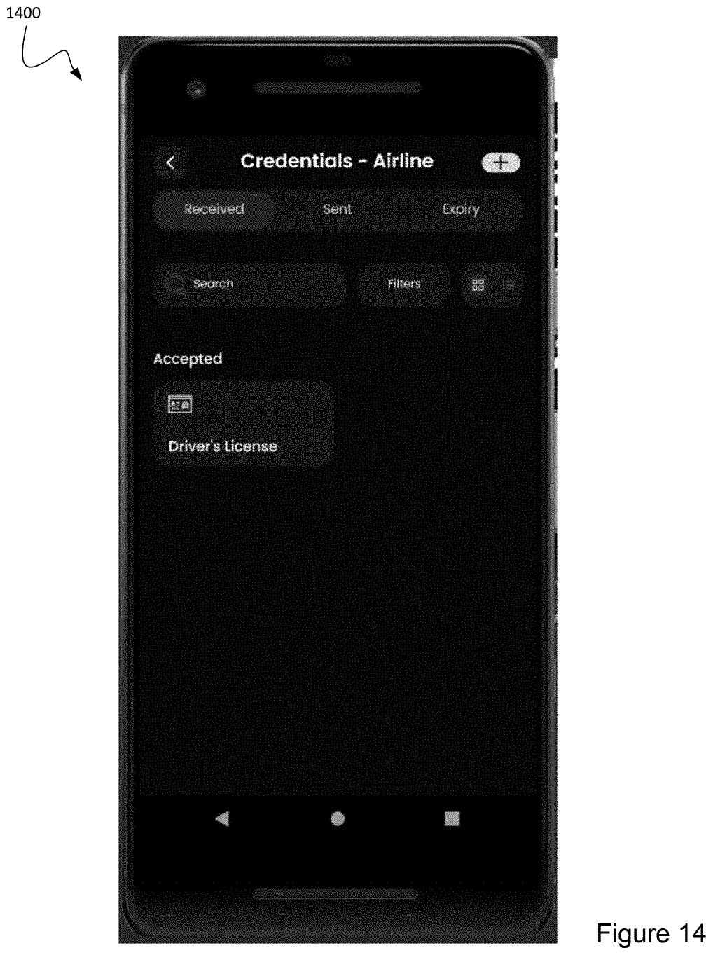

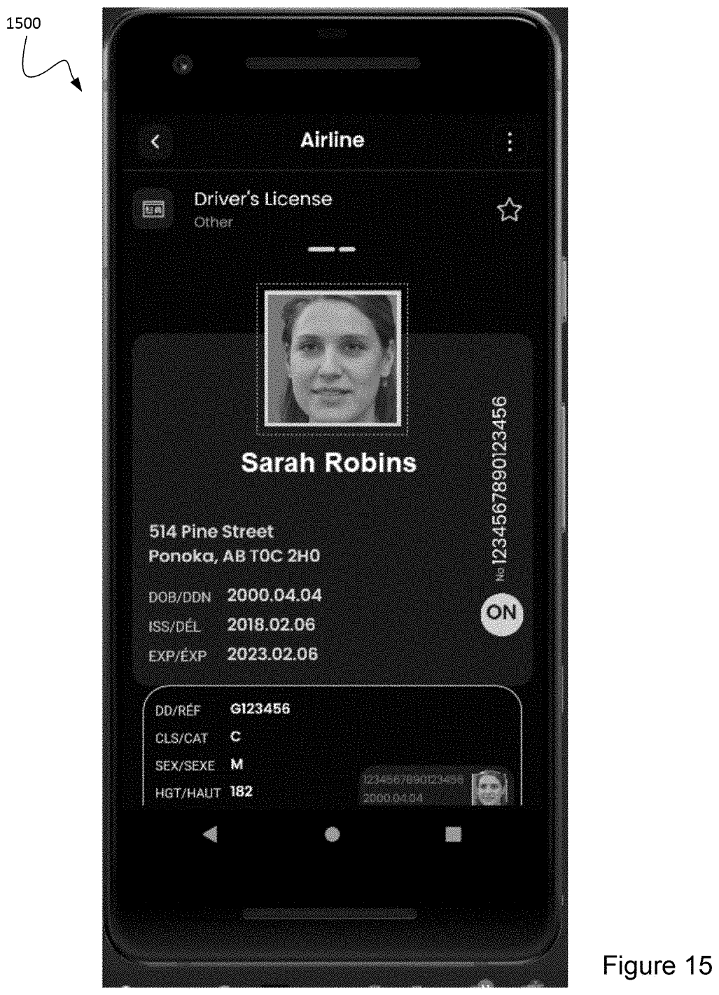

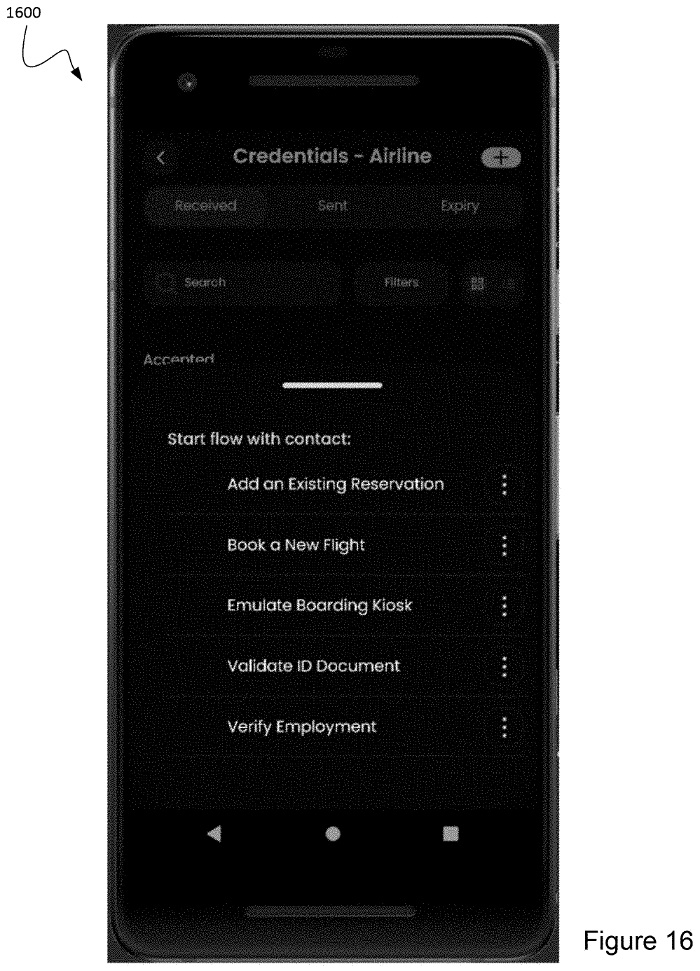

An example interface 1400 of the digital wallet 1200 shows a listing of the credentials. See FIG. 14. An example wallet-side workflow to add such credentials is initiated in the example interface 1600 of FIG. 16. Further, an example interface 1500 in FIG. 15 shows a verifiable credential, in this instance a sample driver's license.

There is a special type of VCs that can protect its raw information. These special VCs are known as Zero Knowledge Proofs (ZKPs). ZKPs typically provide a binary answer to a question (true/false or yes/no) but they maintain the authenticity and integrity of the data through special cryptography algorithm that executes within the wallet 1200.

For example, an agency may be interested in finding if a customer is over 18 years of age. While the agency may request the DOB as a Verifiable Credential, requesting a ZKP may avoid exposing this sensitive information. The ZKP may be framed as “Is Customer older than 18?”. In this case the ZKP value may either be a “yes” or a “no”.

Workflows

Workflow Editor

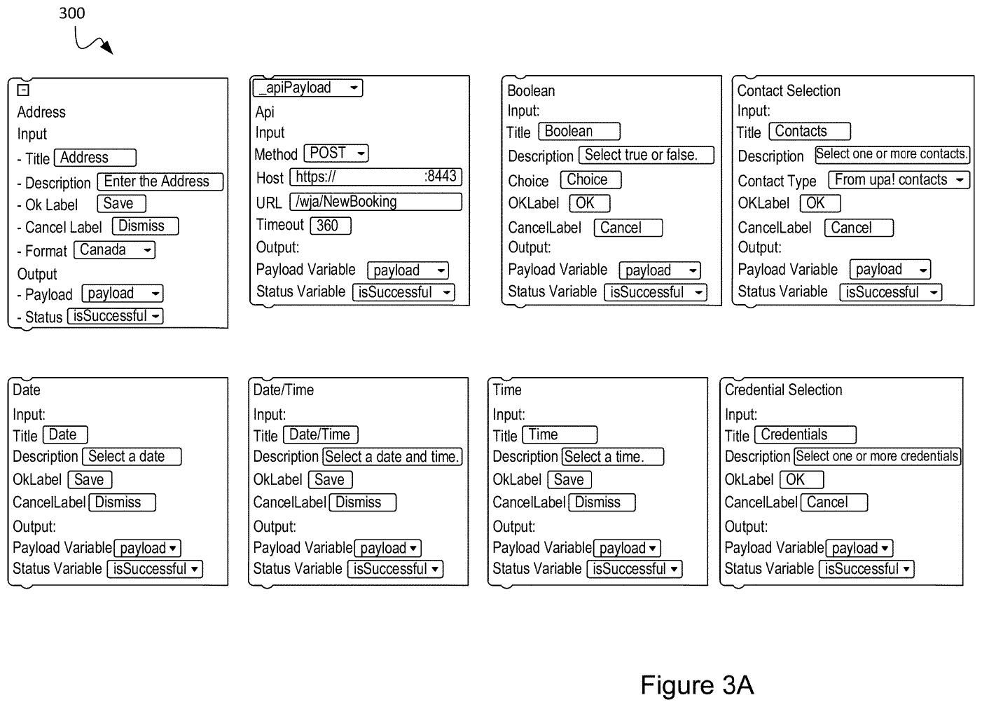

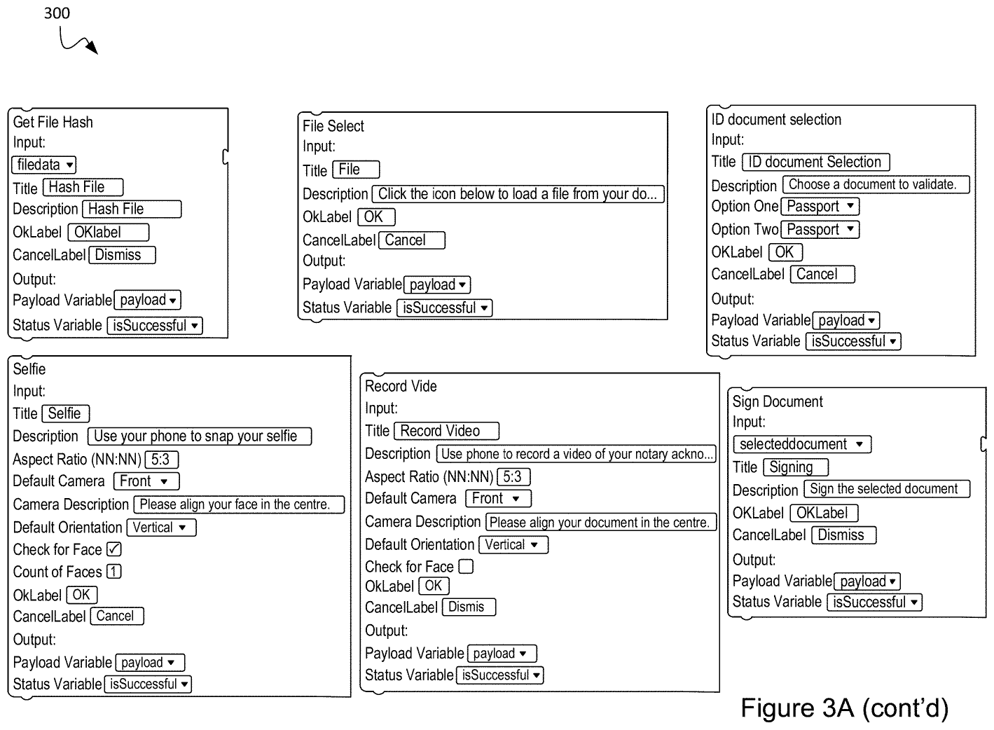

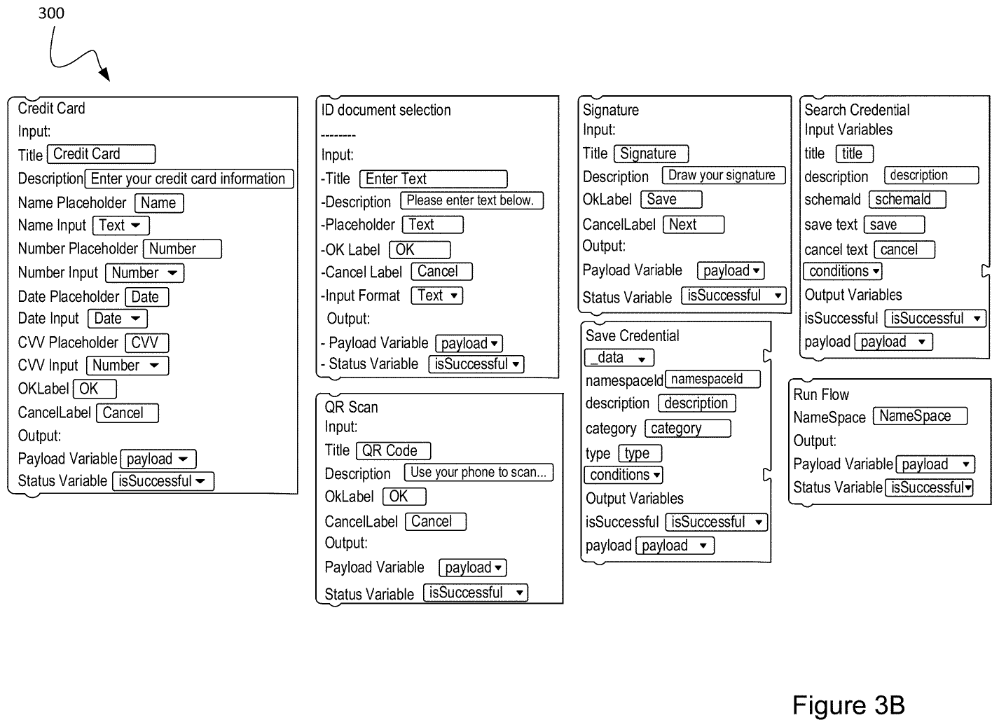

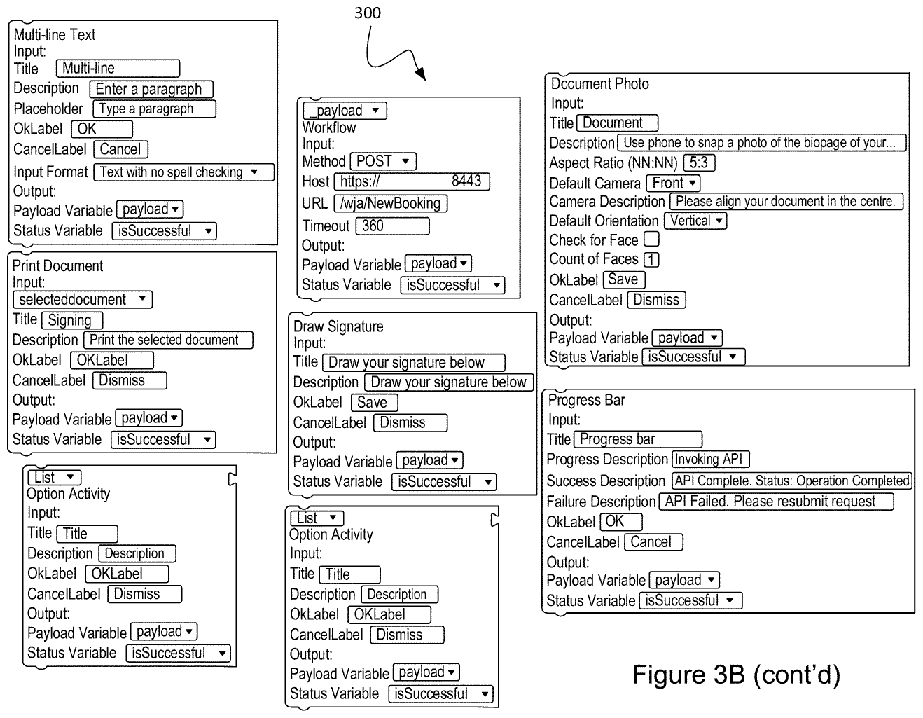

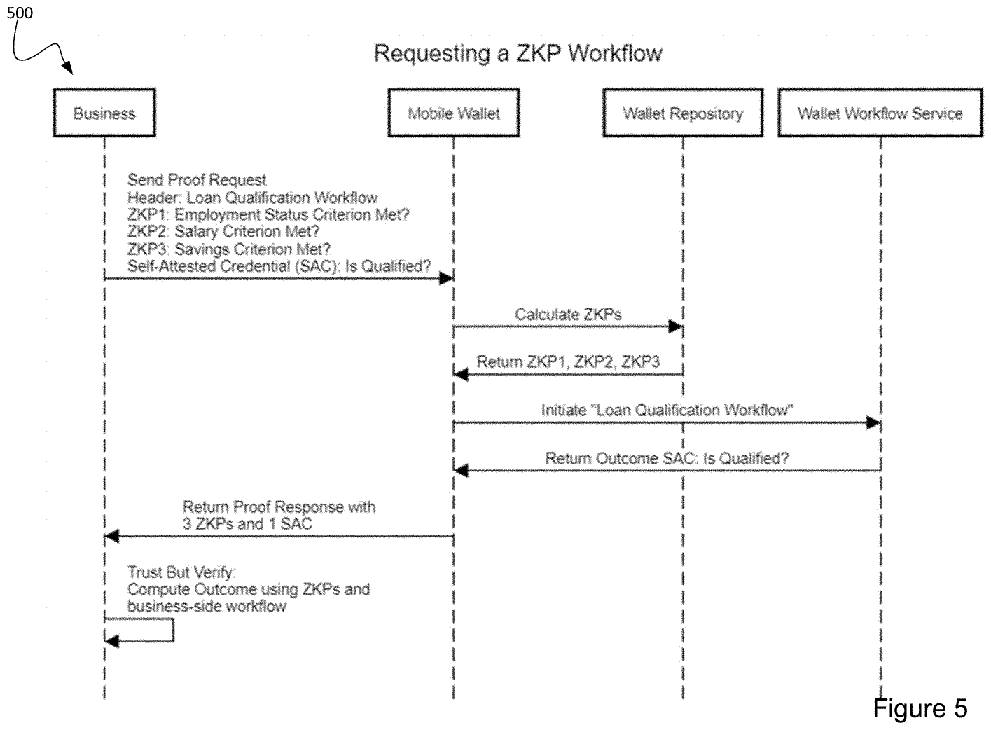

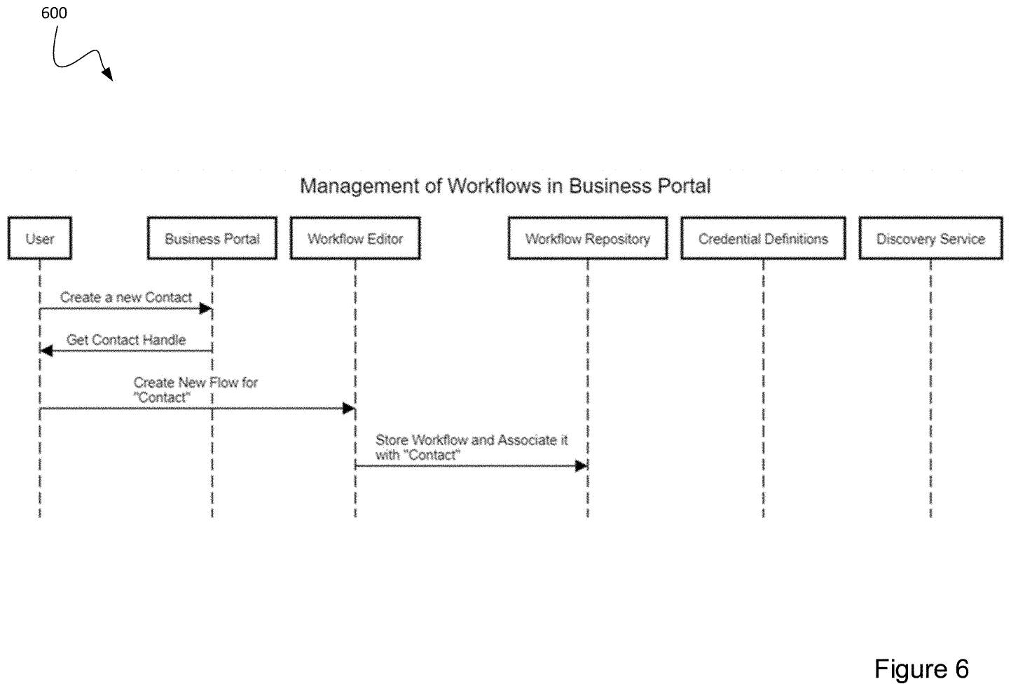

The example workflows are created using a tool referred to as workflow editor, which is hosted on the business portal website. The workflows are built by assembling together a set of blocks 300. See FIGS. 3A and 3B. The constructed workflow is then converted into code which is then stored in the business portal, and is associated with the agency (or contact) that created them. FIG. 6 shows a sequence diagram 600 for creating and publishing a workflow to the workflow repository.

The workflow is split into a wallet-side and server-side implementation. The two-parts work hand-in-hand to process any data which is requested by the server and delivered to it from the wallet.

When a user connects with the contact or agency using the digital wallet 1200, the associated wallet-side workflows get listed under that contact.

A user can initiate any of these workflows by selecting it from the list of workflows. Then the workflow code is retrieved from the business portal and cached in a local database in the app, and then it is executed.

The workflow execution would produce a set of user screens in the mobile app following the workflow logic, user input, and other data that is requested as part of the workflow code. These user screens are rendered based on the configured model of the workflow blocks.

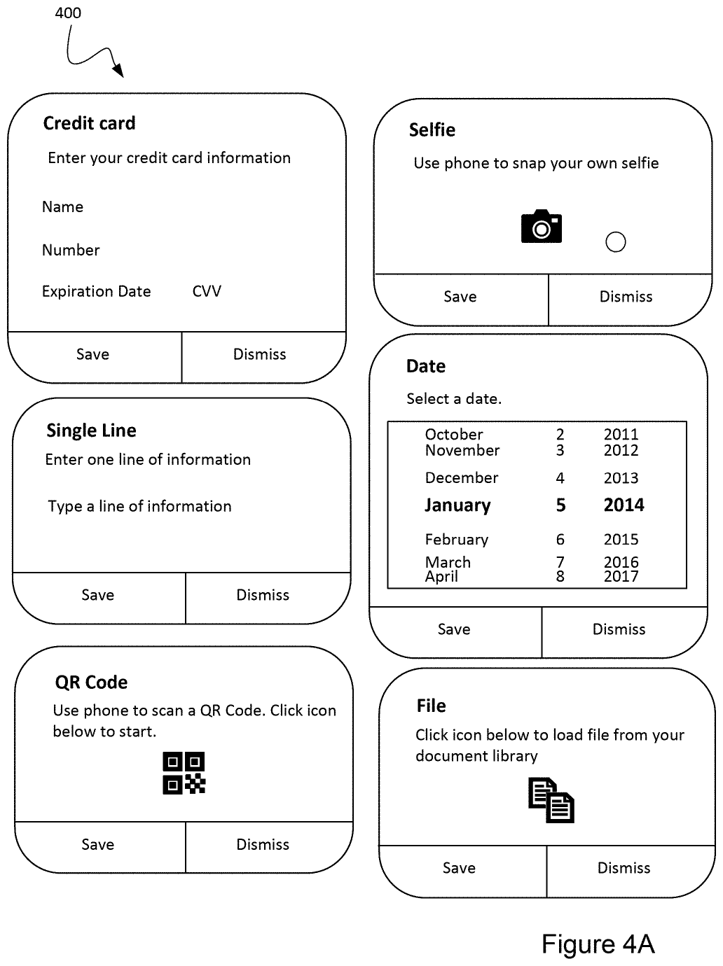

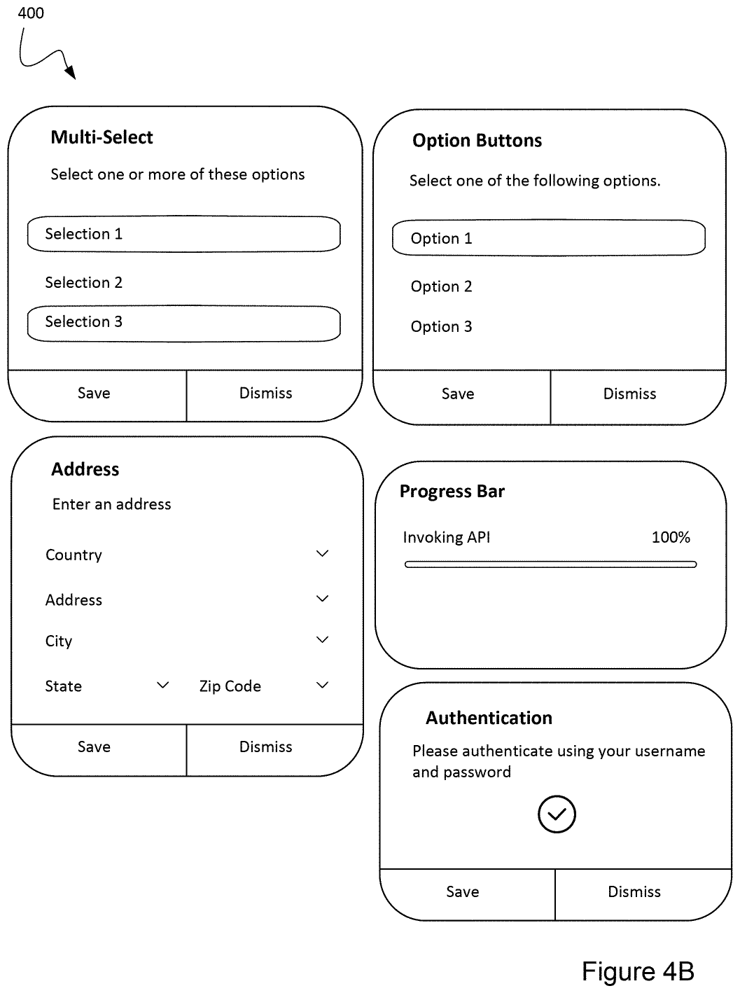

FIGS. 4A and 4B show samples of the rendered workflow blocks 400.

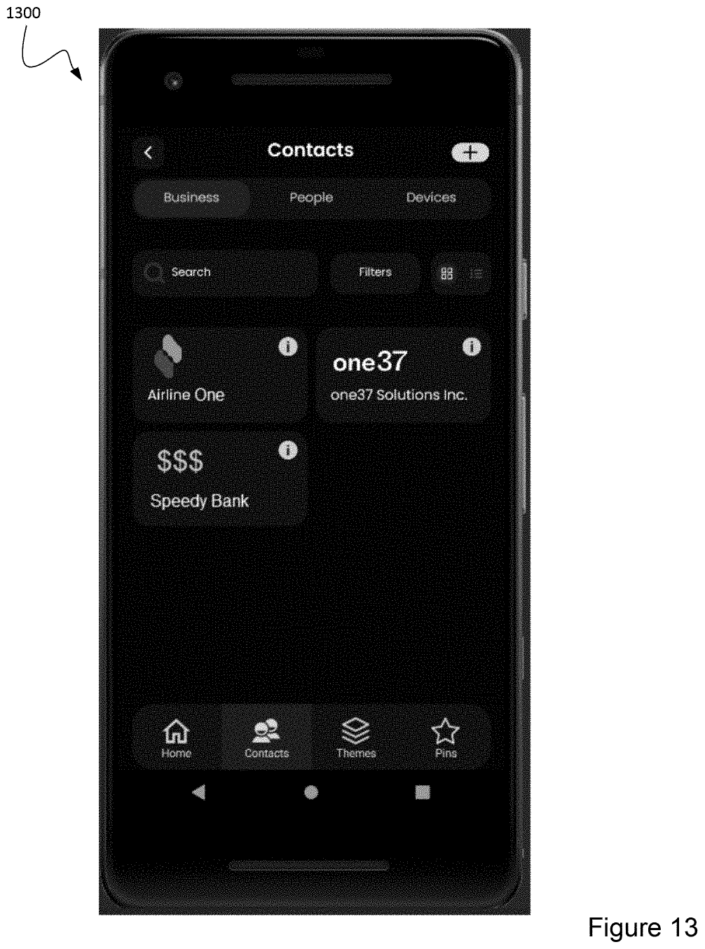

Upon the execution of a workflow, the contact may issue to the wallet a VC. For instance, an ID card validation workflow may result in issuing its owner a VC representing the equivalent digital ID card, which will be stored in the digital wallet of the user. See, for example, a contact listing interface 1300 in FIG. 13.

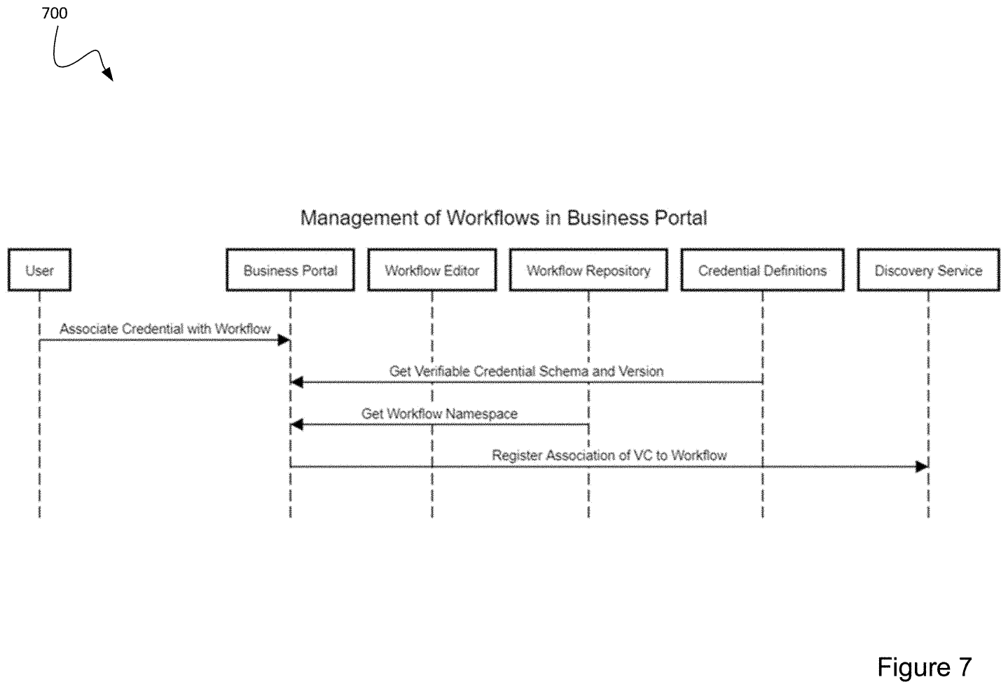

To that effect, a workflow may be registered as a source of issuance of a certain VC type. To do that, the administrator of the agency may create an association between these VCs and the corresponding workflows that may produce them by registering them in a discovery service. See, e.g., the process 700 of FIG. 7.

Workflow Blocks

Workflows on a mobile device are implemented using a set of workflow blocks that can be stitched together and configured with appropriate input. Each block is designated to collect one specific type of input, either directly from the user of the application, or from the data already in the wallet 1200.

Data that is collected directly from the wallet 1200 is considered at this point self-attested as it is not associated with a proof request.

These blocks 300 can be supported out-of-the-box in the digital wallet. See FIGS. 3A and 3B.

Data Entry Blocks:

Address

Options

Multi-select List

Boolean

Date/Time (with localization support)

Date only

Time only

Date and Time

Single Line

Simple text with/without spell checking

URL

Phone (with support for country code)

Email

Amount with configurable currency symbol (localization)

Password

Number (localization)

Multi Line

Automation

Read Barcode

Progress Bar

File Browser (need to check size limit)

Support of multiple select

Get hash-only of file(s)

Support of media documents from library

Select Contact(s)

From Contacts

From Phone Address Book

From LDAP

By Alias

MessageBox

Credit Card (localization)

Send Basic Message

Share document through a Social App

Invoke Wallet-Side Workflow

Initiate Server-Side Workflow

Invoke Remote API

Security

Digitally Sign Document

Authentication

Get OAuth/Bearer token

Request specific claims

Get Credential from Wallet

Find by restriction

Generate proof proposal

Media

Start live video chat

Snap a short video

Capture Signature as a photo

Get Selfie

Find a specific number of faces

Extract Faceprint

Compare Face Match

Get photo of a document

Print document

Data

Save Self-Attested Credential

Get value from JSON

JSON Constructor

Wallet-Side and Zero Knowledge Proof Workflows

Workflows may run in the digital wallet 1200, allowing the data from the wallet to be readily used and avoiding the need to send the raw data which is used in decisioning outside the device.

In order to deliver a trusted outcome, the workflow must show proof of processing and execution of key decision points, relying on Zero Knowledge Proofs (ZKPs), which yield a binary outcome (true or false) without disclosing any additional information or knowledge about the original data behind it. These workflows are referred to as ZKP workflows.

The ZKP workflows are initiated by sending to the wallet a request for a set of ZKP, along with the request for a self-attested outcome which is the result of processing the various ZKPs through the workflow.

For instance, to evaluate if a bank customer qualifies for a mortgage using a ZKP workflow, the customer would need to prove:

Customer has a job;

Customer has an annual salary is greater than 20% of property value; and

Customer has a savings account with a balance greater than 10% of property value.

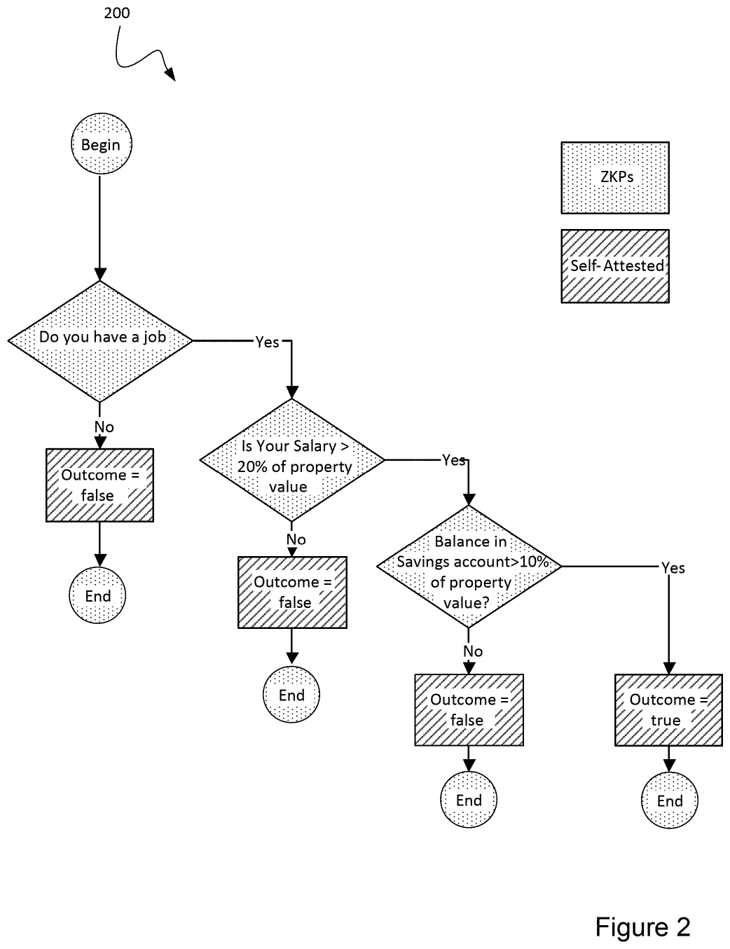

FIG. 2 shows the processing of an example ZKP workflow 200, where the response that is sent back to the requestor (financial institution) is a set of 4 answers; 3 answers are ZKPs (Job Status, Salary Status, Savings Account Status) and 1 self-attested proof (Outcome).

While the outcome is not ZKP (not signed and a result that can potentially be falsified), the three other ZKPs can be used by the financial institution to perform the same validation on its side and recalculate the outcome which match the same value as the outcome that was calculated on the mobile device.

FIG. 5 shows an example process 500 of executing a ZKP workflow.

Server-Side Workflow

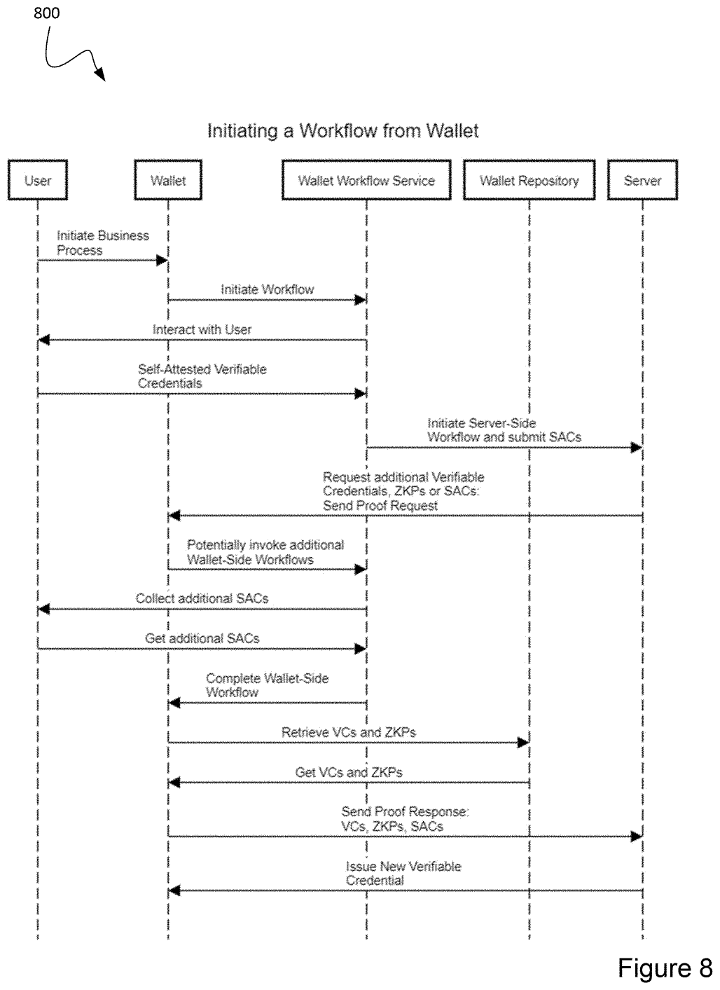

The example in FIG. 5 shows a wallet-side workflow which is initiated as a result of sending a proof request to the wallet 1200. In other cases, a workflow 800 may be initiated by the user of the wallet. The workflow may collect data which is then sent to the server to process it before also sending additional proof requests to the wallet. See FIG. 8.

For example, a user may want to perform an ID card validation. In this case, the user will initiate the corresponding workflow from the contact's available workflow. The workflow will request the user take their selfie, take a photo of the two sides of their ID card, and then send this data to the server to complete the validation of the document. The collected data at this point (selfie and two sides of the ID card) are all Self-Attested Credentials (SACs), which are not signed other than by the wallet owner.

To complete the validation of this data on the server, the wallet invokes the server-side workflow by executing a special workflow block called initiate server-side workflow. This activation of the server-side workflow and the transmission of the data happens securely through the DIDComm protocol and ensures that the server-side is receiving the data as created or collected from the right wallet.

VC UI Templates

VCs are data structures that are signed and contain data that resembles to some extent a dictionary of key/value pairs. The value of an attribute may contain any type of data, including other nested dictionaries.

VC can be issued based on a corresponding schema, which has two special attributes; a name and a version. As such, the wallet 1200 can leverage these two attributes as well as others (for example, a custom attribute called namespace) to find a corresponding UI template which can be used to render the content of the VC when viewed in the wallet.

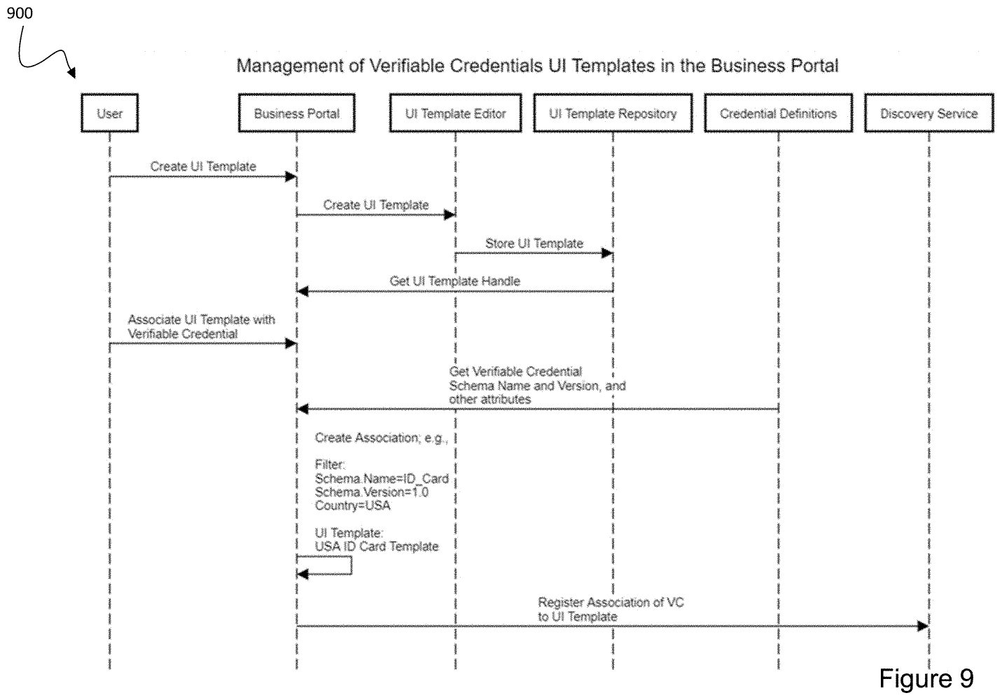

FIG. 9 shows an example process 900 to create and register the VC UI templates through the business portal.

In addition to UI templates, VCs may also be associated with icons of different size for different platform (mobile, web . . . ) to display a thumbnail representing the VC listing in the Wallet. Following the same process as in FIG. 8, the wallet 1200 can also discover and download a VC's corresponding icon.

Workflow Versions

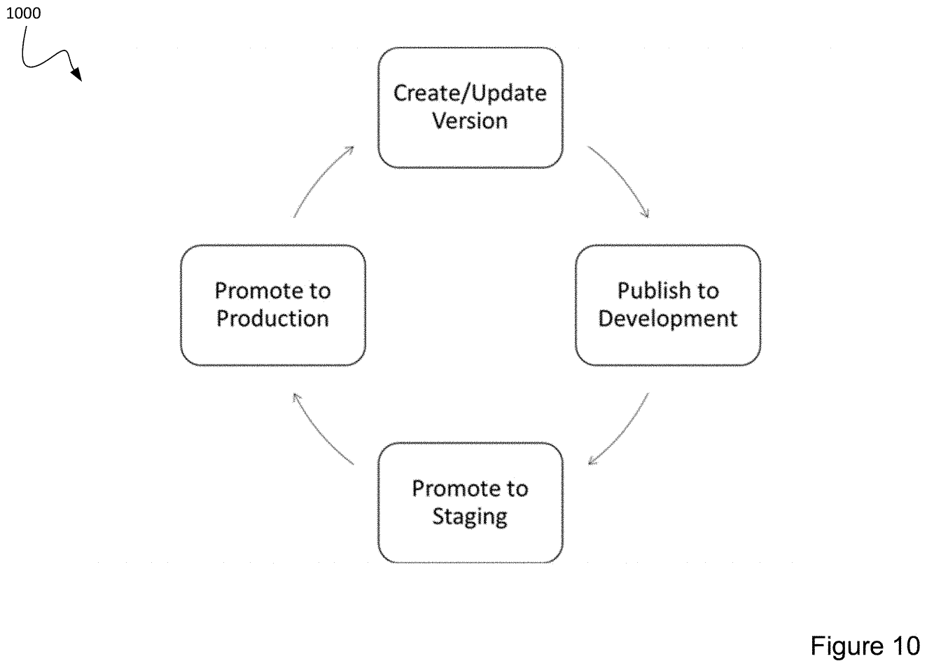

Workflows are versioned and follow a prescribed lifecycle 1000, which would allow them to be initially created, then published into a development deployment, then promoted to staging and finally production environment. With each update cycle, the workflow instance will assume a new version number, allowing the wallet to pull a specific version designated by the agency or its designated administrator. See FIG. 10.

VC Service

Some VCs may have associated control instructions that dictate how these VCs are handled at the time they are received by the wallet 1200 or requested by a proof request. These control instructions can either be embedded within the VCs using special attributes with reserved names, or can be published in the business portal and associated with a specific Agency. For instance, an ID card issued by Agency A may have different control instructions than an ID card issued by Agency B. These control instructions are stored in the workflow repository and associated with a specific VC through the discovery service.

The control instructions can fall into one of three categories:

Triggers—Triggers are event-based action that instruct the wallet how to handle their corresponding VCs. Triggers would refer to workflows that will be initiated as a result of the corresponding event taking place:

Trigger.OnReceive: this event is triggered when a credential is received in the wallet (but not yet accepted).

Trigger.OnAccept: this event is triggered when a credential is accepted and stored in the wallet.

Trigger.OnBeforeDelete: this event is triggered at the time the credential is about to be deleted from the wallet.

Trigger.OnShare: this event is triggered when a VC is about to be sent as part of a Proof Response.

Trigger.OnBeforeView: this event is triggered when opened in the wallet, but just before it is rendered through its UI Template.

Trigger.OnAfterView: this event is triggered when opened in the wallet, and just after it is rendered through its UI Template.

Restrictions—Restrictions control how the wallet handle VCs. Restrictions are represented as a comma-delimited set of values or a binary bit field where each bit corresponds to a specific restriction:

ReadOnly: A received credential may be rendered one time as soon as it's opened, but is not allowed to be saved. This restriction also prevents the phone from taking a screenshot of the rendered view of the VC.

ZkpOnly: one or more attributes of a VC may only be sent as ZKP and not in their raw format.

LimitToIssuer: a VC can only be requested and sent as a proof to its original issuer only. For example: a digital workplace badge is typically only requested by the employer.

Security—Security Control Instructions provide more control on who has or is denied access to certain VCs. It uses two lists:

allow(order: list): where order specifies the order of applying this rule amongst other rules. The list specifies a comma delimited list of issuer DIDs or aliases that can request the corresponding VC as part of a Proof Request. A value of “*” can also be used to allow all agencies.

Deny(order: list): where order specifies the order of applying this rule amongst other rules. specifies a comma delimited list of issuer DIDs or aliases that are denied access to their corresponding VC as part of a Proof Request. A value of “*” can also be used to deny all agencies.

A combination of an allow(order: *), deny(order: *), allow(order: x), deny(order: x) can be used to control the set of agencies that can request a certain VC. The order of deny( ) and allow( ) is important as later rules supersede prior ones.

Wallet and Contact Triggers

The wallet has a built-in trigger that automatically initiates the discovery of a requested VC which, however, is not present. This process allows the wallet to contact the discovery service and retrieve a list of pairs of issuers and workflows that can be invoked to acquire the missing credential.

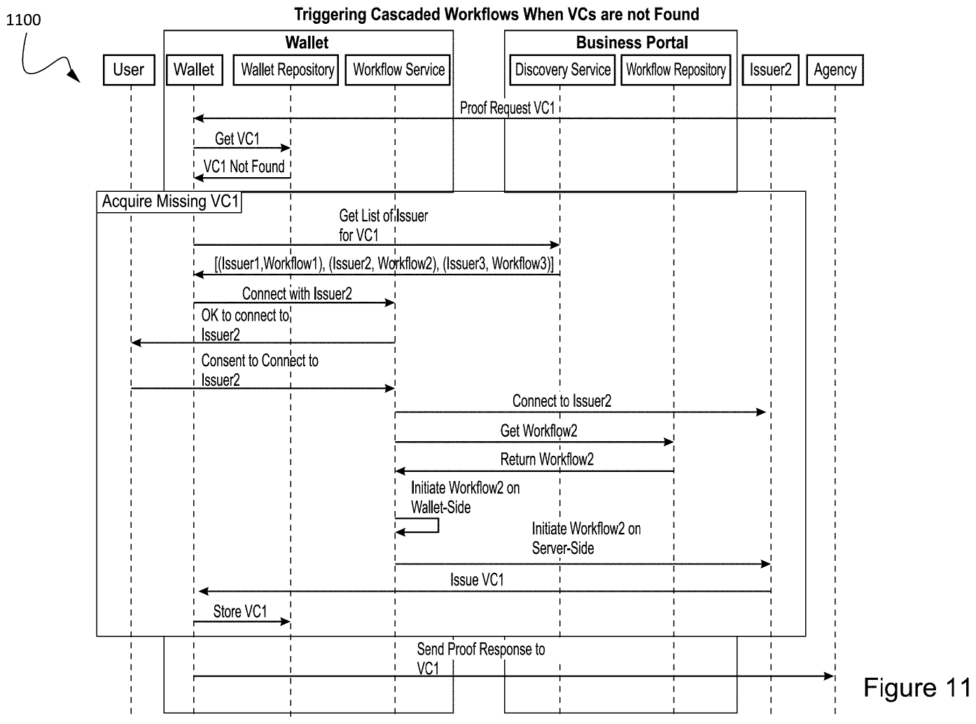

As a result, multiple cascaded workflows can be triggered, where eventually the discovery and acquisition of VC would resume an earlier suspended workflow. FIG. 11 shows how this process 1100 is completed.

Contacts or agencies that a wallet connect to could also have triggers that they can implement. These triggers are published through the business portal into the workflow repository. There are three triggers that each contact may elect to implement:

OnConnect: This event is triggered when the wallet connects to its corresponding contact.

OnBeforeDisconnect: This event is triggered when the wallet is about to delete a contact.

OnAfterDisconnect: This event is triggered when the contact is deleted from the wallet.

Verifying the Revocation Status of Verifiable Credentials

In order to establish proper trust of the VCs, their revocation status need to be checked, preferably every time they are used. Revocation requires interrogating a service that is kept up-to-date by the issuer of the credentials.

In a typical decentralized environment relying on decentralized services to maintain their own revocation list may create an issue over time, especially for VCs that have been issued a while back. To avoid any issues with the availability of the revocation list and still also avoid having to have a centralized revocation list, a distributed ledger is leveraged that can provide significant benefits when hosting the list of revoked credentials.

A public Digital Ledger Technology (DLT) is highly guaranteed to have high availability and continuous availability of nodes that can be queried. In addition, leveraging the distributed DLT can help with monetizing the use of VCs, by implementing a smart contract that can help with the validation of the revocation status while also accepting crypto payments or tokens from a verifier and distributing it amongst the issuers and the network operators.

Revocation Records

The revocation record which is inserted into the DLT would include only a reference to the credential identifier and its issuer. The presence of a revocation record on the DLT signifies that this VC is no longer valid.

The absence of such record from the DLT means that the VC can still be considered valid.

Revocation Smart Contract

To ensure that the revocation records would need to be retrieved through the smart contract, the latter will hash the revocation records by using a secret key when inserting a new record. This ensures that a verifier cannot bypass the smart contract and directly look for a specific revocation record in the DLT.

To retrieve a revocation record through the smart contract, the verifier is required to specify the issuer of the credential and its unique identifier only. This continues to ensure the privacy of the VC's content and its holder.

Custom Attributes in DID Schemas

A generic schema can be used as a super schema to store data into a special attribute called ‘value’. The schema would ensure that some agency may be able to issue and exchange credentials when they do not have their own credential schema or definition.

In addition, additional attributes can allow the handling of special workflows known as experiences.

The following is a version of the generic schema with the out-of-the-box custom attributes:

```
{
  “schema_id”: “schemas.com.company.generic:1.0”,
  “schema_version”: “1.0”
  “state”: “written”,
  “created_at:” “2021-01-01 19:39:38:604964Z”,
  “author”: “self”,
  “attributes”: [
    “.namespace”,
    “.trustLevel”,
    “.category”,
    “.type”,
    “.description”,
    “.icon”,
    “.value”,
    “.valueschemaname”,
    “.valueschemaversion”,
    “.isexperience”,
    “.validity”
    ],
  “schema_name”: “schemas.com.company.generic”,
  “updated_at” “2021-01-01 19:39:38.605964AZ”
}
```

An example of attribute values follows:

| | |
|---|---|
| .namespace: | com.airline.employment. |
| | accessbadge |
| .trustlevel: | 3 |
| .category: | Identity Credential |
| .type: | Workplace Badge |
| .description: | credential issued to an |
| | airline ticketing |
| | counter agent |
| .icon: | http://example.com/ |
| | icon.png |
| .value: | { . . . JSON |
| | Content . . . } |
| .valueschemaname: | schemas.com.airline. |
| | security.accessbadge |
| .valueschemaversion: | 1.0 |
| .isexperience: | false |
| .validity: | IsCredentialExist |
| | (com.airlines. |
| | employment. |
| | isemployee) AND |

```
  Value(com.airlines.employment.location)==
”locations.airports.yyc” AND
    DateTime.Today <= “2023-04-23”
```

namespace—A unique identifier that can be used when filtering or looking for a specific credential.

.trustlevel—A value between 0 and 3 representing a corresponding Assurance Level to those used in NIST 800-63. Level 0 represents a credential whose value was not verified. Level 1 represents low assurance level based on one factor. Level 2 represents an elevated assurance level based on digital verification of the content. Level 3 is the highest level of assurance and indicates that the verifier has done some manual checks on top of a digital one to verify the trustworthiness of the data.

.category and .type—Are used to classify visually and logically in the wallet the credentials under one contact.

.description—As the name indicates it describes what this credential is about.

.icon—A graphics file used to represent the credential when listed under a contact in the digital wallet.

.value, .valueschemaname and .valueschemaversion—The .value holds custom JSON content that can be interpreted by its corresponding issuer or verifier. The .valueschemaname and .valueschemaversion would allow the consumer of the credential to dynamically validate and parse that content. This schema is therefore generic in nature and can provide future-proofing to new credentials that are not available at the time of implementation.

.isexperience—Some credentials will carry this special flag which designates some credentials as the basis of an event associated with a time and location. For example, travel plans are experiences. A trip to a theme park is an event.

.validity—Is a logical condition that governs the validity of its corresponding credential. Thus, credentials can be made reliant on other credentials, or associated with a time expiration, a location or a combination of multiple of these factors. The .validity calculation results in a binary value (true or false) that indicates if the content of the credential is still valid or not.

Special Credentials

Geofenced, Temporal and Other Sensor-Aware Credentials

Verifiable Credentials residing in the wallet may carry various metadata and can automatically trigger events. One such metadata is a tagged geofence that allows the credential to notify the wallet once the user is within a certain geofence.

For instance, upon coming close to an airport, the boarding pass credential can trigger the wallet to display it on the homepage of the app, making it more accessible to the user.

In a similar case, a credential representing the badge of an employee would be triggered to be displayed when the employee approaches the office building and is getting ready to present it.

Other metadata that can be tagged to credentials may include timestamps and associated events. Examples of such metadata include: a reminder to use an eTicket to check-in to a flight; a digital coupon which is about to expire; and/or a driver's license needs to be renewed; etc.

With the use of other sensors on the mobile device, credentials can be tagged with other more advanced attributes that could leverage movement, acceleration, temperature, orientation, magnetic field, light conditions, sound and noise levels

Dynamically Pinned VCs

Pinned VCs are more commonly used credentials that the user may select and pin in a special location in the Wallet for easier access. For example: the VC used to access a gym, or a workplace badge.

In addition to the manually pinned credentials, the sensor-aware credentials may automatically pin themselves as their trigger condition is met. As soon as these conditions are no longer valid, these credentials would be automatically removed from the Pins section of the app. For example, when approaching the airport, the boarding pass credential may get automatically pinned. When approaching the office, the workplace badge is auto-pinned. When the time is within few minutes from the start of movie, the e-ticket credential is automatically pinned.

Physical Proof of Presence and Enhanced Physical Proof of Presence

Physical Proof of Presence

Physical Proof of Presence (PPP) is a special type of VC that can be requested by an entity (typically a Business Agency).

The purpose of the PPP is to ensure that the specific individual whose identity or other requested credential(s) are being requested is the one that is currently using the wallet and is consenting to the release of the requested data.

This Proof Requests translates automatically into a group of VCs that are requested as well as a wallet-side workflow that is triggered prior to sending back the proof response.

The PPP proof request would include from the digital id the following attributes: first name, last name, Date of Birth (DOB), and photo. The request would also include the initiation of a workflow which would request the user to take their own selfie, and upon the completion of this request, the face print of the selfie gets compared to the face print of the photo from the digital wallet.

If the two face prints match, then a proof response which includes the first name, last name, DOB, photo, and selfie would be returned to the requestor.

Enhanced Physical Proof of Presence

The Enhanced PPP (EPPP) requires a Trusted Location (TL) VC issued by a wireless carrier to be sent along the VCs in the proof request. If the TL VC is not available in the wallet, a workflow is identified through the discovery service, and the TL is acquired and then added to the proof response of the earlier proof request.

Aliases

SSI wallets can leverage QR codes to initiate sessions between entities. QR codes can visually represent more complex data, such as Decentralized Identifier (DID) strings, connection endpoints and public encryption keys. The more data that a QR represents the more complex the resulting QR image becomes. Very condensed QRs can be difficult to scan with lower quality scanning hardware.

Even a subject's DID, which in some SSI systems is a unique address reference to the actual published discovery document (DIDDoc), is usually represented as a long complex string that is not easily read or remembered by humans.

Thus, it is difficult for two entities without a line of sight to exchange this information, and therefore QR Codes are not designed for some non-digital channels such as over the phone.

The example wallets herein can leverage a user-friendly handle or reference to the wallet connection metadata. This reference is known as an alias.

A wallet can have one or more aliases which are user friendly and can be communicated over the phone. Once an alias is communicated to the remote party, a DIDDoc or other discovery metadata can be resolved for the initiating party.

The connection information in the metadata, such as authentication endpoints, can thereafter be used to connect with the remote party and complete the over-the-wire authentication, using secure methods such as those used in SSI, and verified through digital cryptography to check for authenticity and integrity of the communication.

Types of Aliases

There can be three (3) types of aliases:

Static Aliases—These are aliases that have long term durability and are usually predetermined strings related to the subject such as mobile phone, email, social network handles, or domain names for businesses. Users may also register aliases of their own choosing if the value is unique in the system. Static aliases can be easily remembered by their owners but are also easily guessed by remote parties and may result in causing annoyances to their owners.

Dynamic Aliases—Dynamic aliases are always a calculated value, six or seven characters long, and have a short lifespan, typically 60 seconds or less. These dynamic aliases would be generated by the wallet application and would typically be communicated over a phone with another party to perform a remote identity verification without having to see the phone of the other individual.

Due to the short lifespan of a dynamic alias, it would be very inefficient to register that alias on the server and perform a lookup every time against all other values. To address this issue, the alias is not registered, but instead is calculated on both the server and the user's device using a modified version of the original TOTP algorithm which is documented in RFC 6238. We refer to this new algorithm as the Universal TOTP (UTOTP).

Temporary Aliases—These are aliases meant to be used for a short duration but could still last from a few minutes to a few days. These aliases can be used for instance during a day trip to an amusement park or one-day pass to a conference. They can be extended for a few days as in the case of a hotel room key or for use when creating a group of contacts. Temporary Aliases are like dynamic aliases in the sense that their value is randomly generated, however not using the TOTP algorithm. However, they are also like the static aliases when it comes to the need to have them registered in ARS before they can be verified and resolved.

Format of Aliases

Static Aliases Format

Aliases can be any set of words or sentences that are universally unique.

Aliases follow the same rules as designated in RFC 5322 for the use of characters in email address.

Aliases are managed through a centralized service to guarantee uniqueness.

Users who have verified contact information (email, phone, mobile, social network handles . . . ) would automatically get them as aliases. Users have an option to continue reserving these verified handles but can decide not to make them used as aliases (deactivate resolution).

The alias value can easily be communicated in a text or email, over the phone or in any kind of audio or video clip (advertisements etc.).

Dynamic and Temporary Aliases Encoding

Dynamic aliases are encoded with base 16 encoding for shorter values with a modified mapping which makes it easier to transmit over the phone. The modified mapping between the values and the alphanumeric characters eliminates numbers or letters that are hard to pronounce over the phone. For example, our modified base 16 encoding maps the value 0 to 15 to these characters: A, C, E, G, H, I, J, K, M, N, O, Q, R, U, X, Y. The mapping is designed such that vowels are properly spread in the encoded 6 or 7 letters that are generated by base 16 encoding the TOTP code using these 16 letters.

Alias Resolution Service

To operate over the DIDComm protocol, the wallet and agencies require the establishment of a connection. The connections are formed using having either entity reaching out to the connection endpoint over a specially crafted URL and exchanging authentication data. This special URL is known as the Invitation URL.

To make these invitation URL usable, they are often encoded into a QR code, and that makes their use limited to mobile devices that can scan them. To extend their use to other channels such as over the phone or on web browsers in devices that do not have camera, aliases can be leveraged.

An alias, in any of its types, can therefore be resolved to its corresponding invitation URL.

The Alias Resolution Service (ARS) is implemented as an agency supporting DIDComm, providing protection against spammers or unauthorized users who are not using a Digital Wallet. The ARS will have an agent endpoint which is used for communication with other agencies or wallets.

Static Aliases

Registration of Non-Custom, Contact Info Aliases

Static aliases can be either verified contact information, such as a verified email or a verified mobile phone number, or custom aliases which can be any unique data entity meeting the criteria set forth for static aliases earlier in this document.

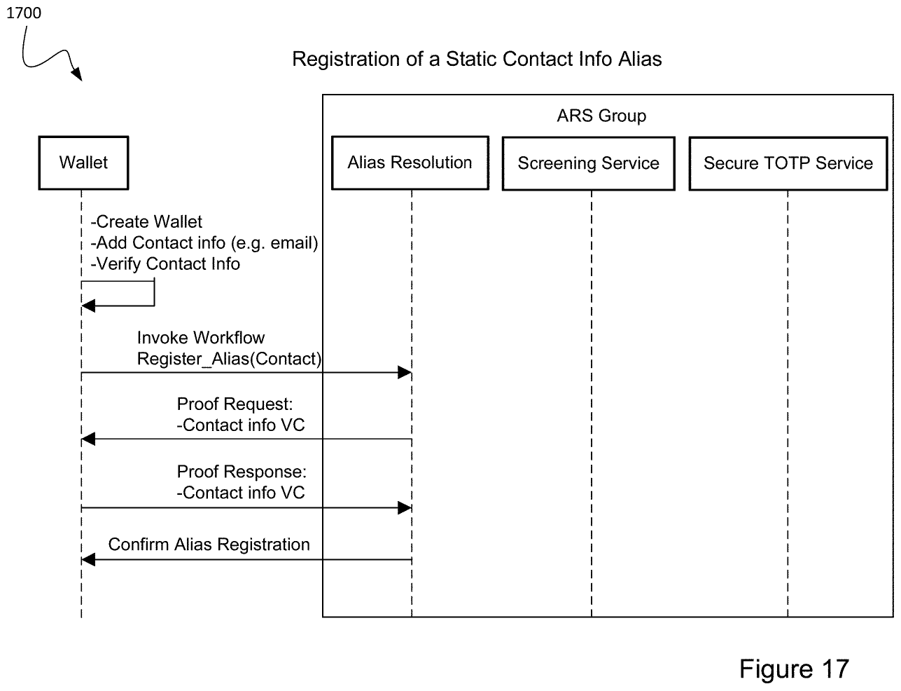

Static contact info aliases are optionally registered by the owner of the Wallet once the contact information is verified. See FIG. 17 for the example process 1700 of registering these aliases in ARS. The process requires that the wallet owner prove that the contact information was verified. Therefore, prior to registration, the verified contact is obtained through a proof request.

Registration of Custom Aliases

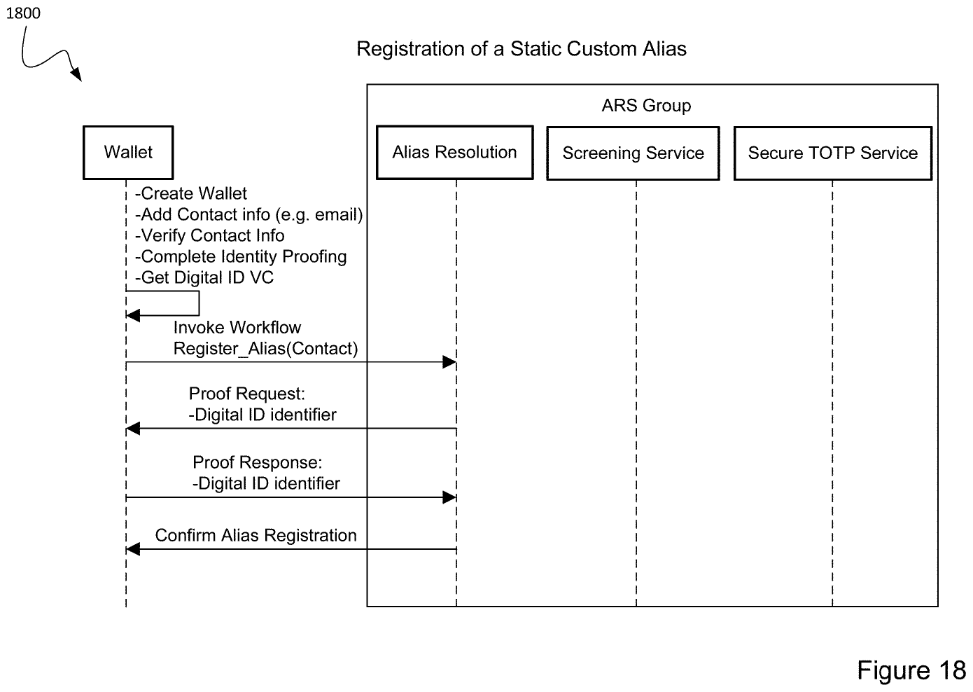

To prevent spammers from registering and limiting the available aliases for other users, custom alias registration requires that user has a validated digital identity. The ARS will also limit accepting registration requests for digital identities issued only from trust identity proofing services. See FIG. 18 for the example process 1800 of registering static custom aliases. The process starts by requesting from the wallet a proof for a digital ID identifier. An example digital ID card schema follows.

```
{
  “attr_names”: [
    “identifier”,
    “dateofissue”,
    “number”,
    “namespace”,
    “category”,
    “dateofexpiration”,
    “trustlevel”,
    “eyecolors”,
    “ddref”,
    “type”,
    “issuingstatecode”,
    “selfie”,
    “weight”,
    “surname”,
    “countryofissuance”,
    “dateofbirth”,
    “height”,
    “haircolor”,
    “documentclasscode”,
    “documentphoto”,
    “addressline1”,
    “messages”,
    “adressline2”,
    “sex”,
    “restrictions”,
    “icon”,
    “givennames”
  ]
  “name”: “schema.com.company.identitycard”,
  “version”: “1.6”
}
```

Once received, the alias is registered and assigned its ownership to the digital ID holder.

Resolution

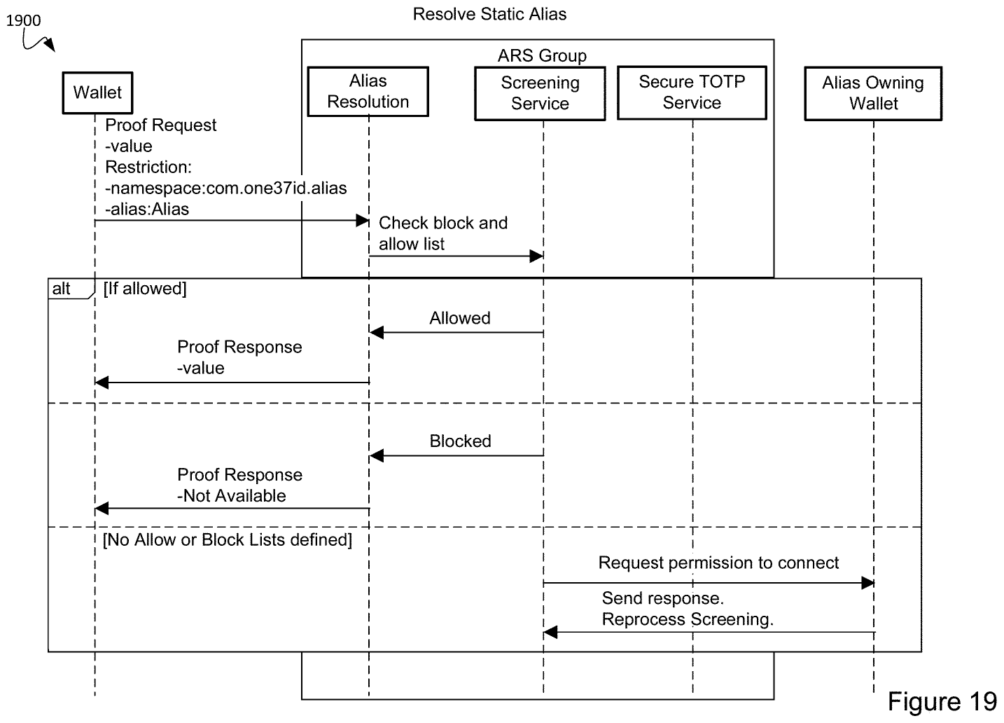

Resolution of static aliases is depicted in the example process 1900 shown in FIG. 19. The only requirement is that the request must be initiated from a DIDComm-capable wallet to block spammers. The alias resolution starts by sending a proof request from the service requesting the resolved alias. The proof request would include a set of restrictions which limits the search to a specific namespace and the specific alias.

The response (alias value) is returned to the caller through a proof response.

Deletion or Updates of Static Aliases

The deletion of aliases follows the same approach as registration, where the requestor must provide proof of ownership of the targeted alias. For contact info aliases, the requested proof would be the verified contact information VC. For custom aliases, the requested proof would be the digital ID card identifier.

Validity of Static Aliases

Contact Info Aliases

Contact info aliases continue to be valid until they're claimed by another wallet owner when he or she can prove that they hold a verifiable credential associated with that contact info. For example: a phone number that was abandoned and was later used by a different person.

Still, in order to prevent the abuse of this process which could result in aliases being hijacked

When a request for transferring an alias occurs between wallets, a previous owner of the wallet will have an opportunity to reclaim the contact alias by verifying it again within a certain period of time before the transfer is complete.

Custom Aliases

Custom aliases are valid based on the validity attribute associated with the alias registration in ARS as shown in the following example data structure.

| | |
|---|---|
| { | |
| “alias”: | “Alias” |
| “owner”: | “digital ID identifier”, |
| “value”: | “Invitation URL”, |
| “validity”: | “2023-04-23” |
| } | |

Upon the expiry of the validity, an alias is automatically unregistered from ARS and is made available for registration by another Wallet.

Dynamic Aliases

Registration

Unlike TOTP, which links the user to one service, dynamic alias can be used with any remote party. And these remote parties would not have the corresponding TOTP seed which keeps the involved entities coordinated. Instead, the remote party must refer to the ARS to validate if the provided dynamic alias is valid or not.

Because of that, the dynamic alias could have a Globally Unique Identifier (GUID) in addition to the standard TOTP code to help the ARS generate the next expected TOTP code for that entity.

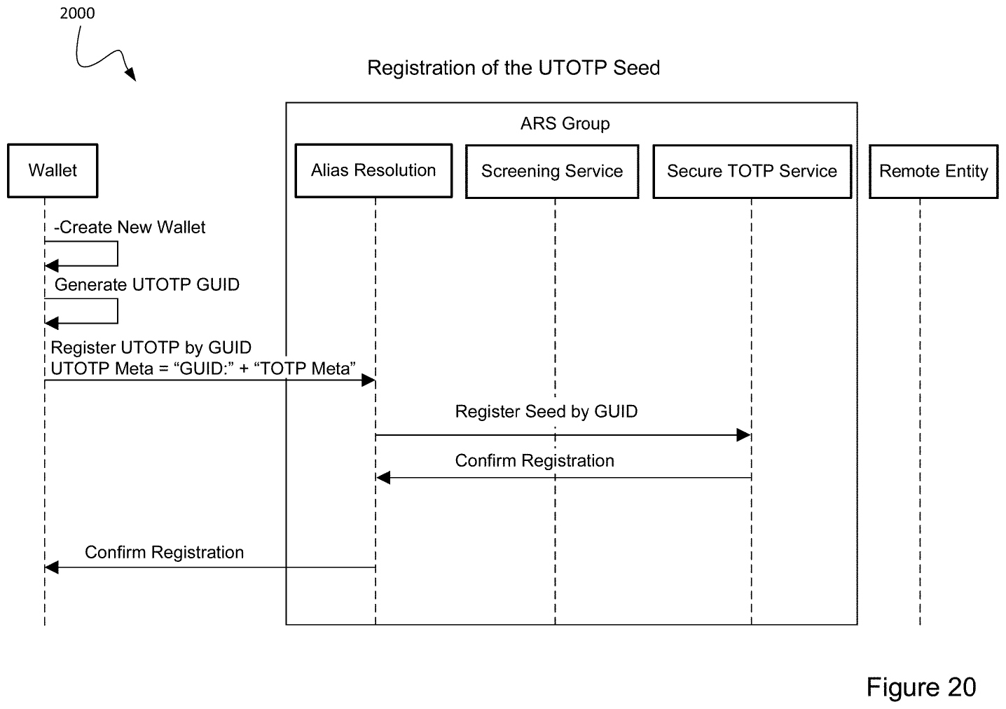

Therefore, when a new wallet is getting created, a wallet unique GUID is created and is sent along with the TOTP seed to be registered in ARS. See the example process 2000 in FIG. 20.

Also, the generated TOTPs will always include as a prefix that same GUID. This new TOTP can be referred to as the Universal TOTP (UTOTP).

UTOTP=GUID:TOTP

FIG. 17 shows the example process 1700 through which a Wallet registers its UTOTP seed.

Resolution

During authentication, when the Dynamic Alias (UTOTP) code is sent to the ARS, the TOTP Seed is looked up using the GUID prefix, and the next TOTP code is calculated. If the calculated code matches the one sent in the Dynamic Alias, then the authentication is validated, and the remote entity gets the Invitation URL of the target entity, if its owner accepts the connection. See the example process 1800 in FIG. 18 for details.

Screening Service

The ARS can provide the alias owner with the choice of maintaining their privacy or the choice of connecting or not prior to having to disclose their identity. This can work provided that either the smart QR (not the Indy Native QR) or an alias are used for communication.

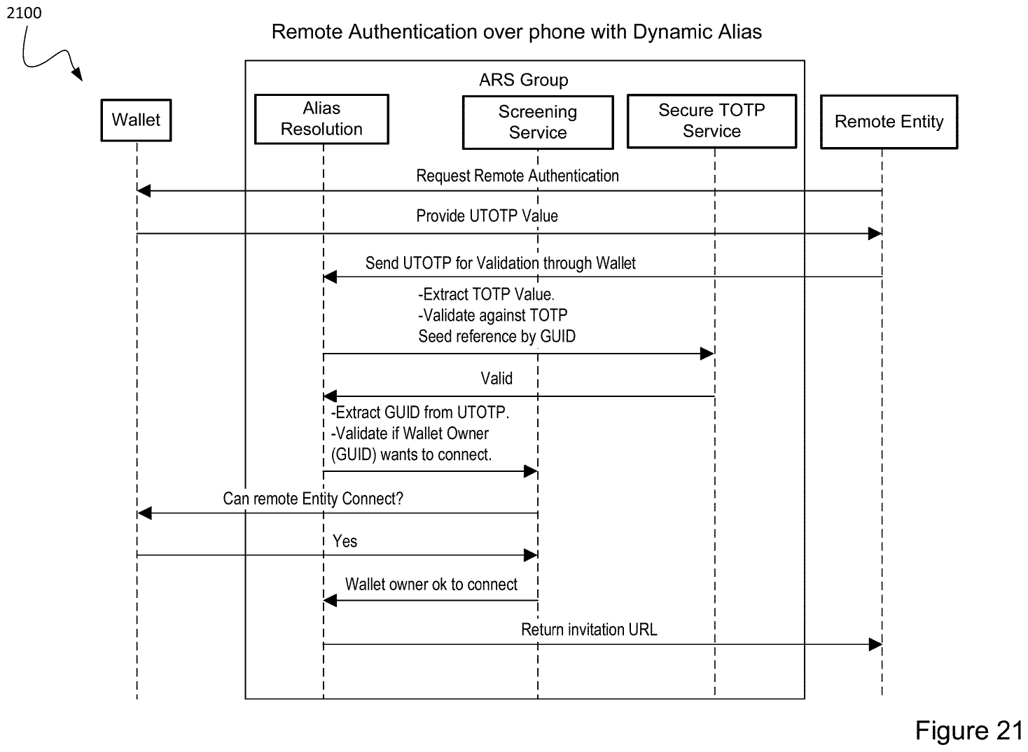

For example, when scanning the homepage smart QR the scanning user's wallet will contact the ARS to attempt to resolve the alias. The ARS would then communicate with the Screening Service (see example processes 1900 and 2100 of FIGS. 19 and 21) to interrogate an allow/block list or to contact the wallet/alias owner if they would allow the connection to take place.

The screening notification to the wallet would include the display name of the requesting party (not the DID as there is no established connection yet).

Using the messaging capability of the SSI connection that the user has with the ARS agency, the receiving party will receive a notification of the request to connect, and they can decide, based the display name, whether to proceed with a session/connection with the remote party or to reject it.

On rejecting a connection, the user can also choose to add the requestor to a blocklist (Do not Disturb) so that future requests are not even processed. The following examples show the structure of the allow and block lists associated with a specific alias.

| { | |
|---|---|
| “alias”: | “Alias”, |
| “type”: | “block”, |
| “list”: | [ |
| | “Digital ID Identifier 1”, |
| | “Digital ID Identifier 2”, |
| | “Digital ID Identifier 3”, |
| | ] |
| } | |
| { | |
| “alias”: | “Alias”, |
| “type”: | “allow”, |
| “list”: | [ |
| | “Digital ID Identifier 1”, |
| | “Digital ID Identifier 2”, |
| | “Digital ID Identifier 3”, |
| | ] |

}

If rejected, the initiating party would not have gained any information or knowledge about the identity of the other party.

Paper Aliases

As discussed, temporary aliases can be generated randomly but can be used for an extended period of time (days vs. seconds, minutes, or hours). As such, a temporary aliases which is generated as a QR can be printed out. We refer to these printed QRs as paper aliases.

Paper aliases are treated as reference to a wallet. Effective use of paper aliases can be in airports where passengers may be able to retain their devices in their pockets while have paper aliases to proceed with the check-in or boarding processes. Upon scanning a paper alias, any proofs are requested from the wallet.

Proof Request Automation

Paper Aliases PIN

As paper aliases may be exposed to the general public (if printed on stickers), this may result in some curious onlookers scanning the QR, which results in non-solicited connection requests to the associated wallet of that QR.

Registration

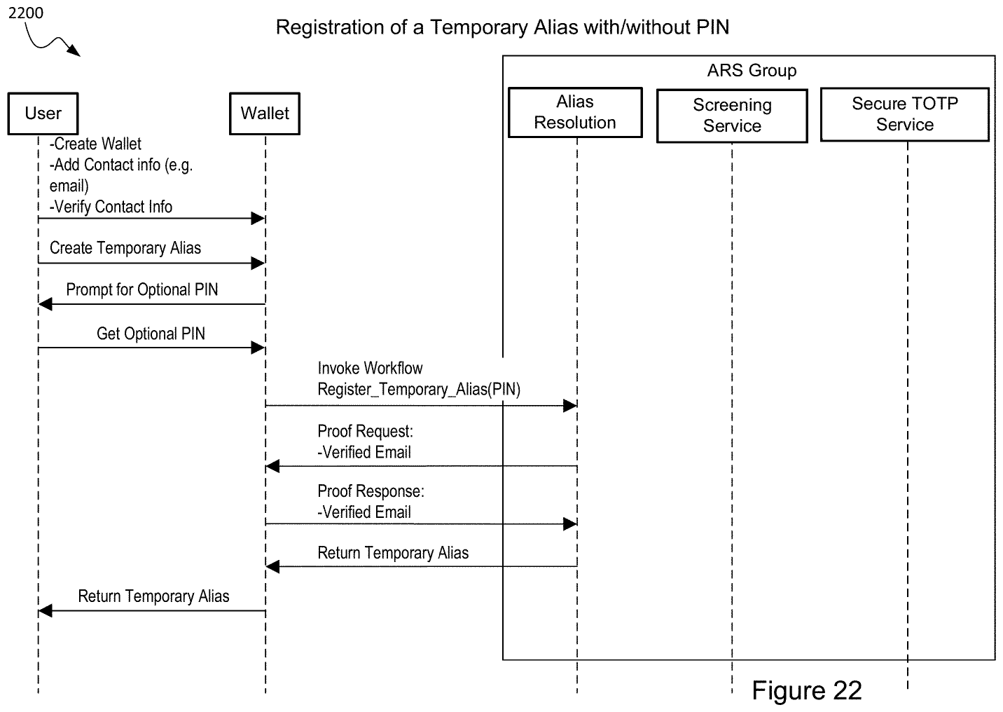

To prevent this from happening, the temporary alias registration in ARS may include sending an optional PIN which would be required to complete the resolution of the alias. The holder of the paper alias may have to provide it to the individual or organization scanning their QR, and thus limiting the unsolicited connections. See FIG. 22 for the example process 2200 for registering the modified temporary alias registration with a PIN.

Resolution

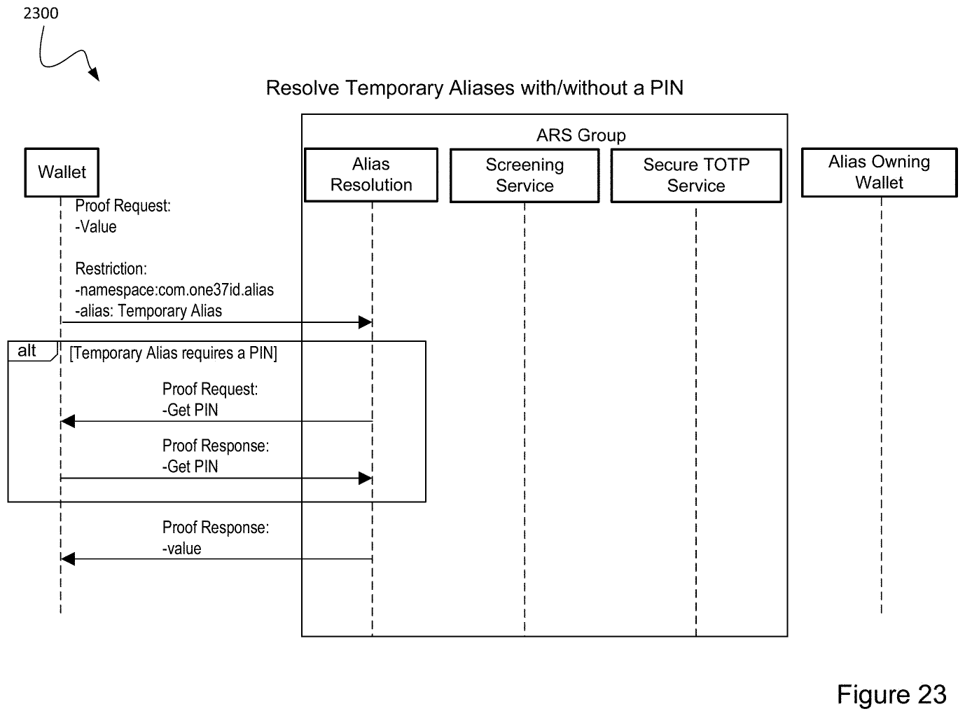

FIG. 23 depicts the example process 2300 of resolving the temporary alias with or without an alias. As this resolution requires a PIN, the screening service would not be interrogated for permission.

Groups

The wallet 1200 allows the creation of groups. Groups would have entities (people, businesses, devices, application, or services) as members. A group would have a temporary alias as a unique identifier and a user-friendly display name that can be referred to within the wallet.

Groups are needed to facilitate use cases such as a traveling group. To check-in, only one QR associated with the group needs to be scanned. The requested data to complete the process for each member will however be retrieved from their respective devices. This makes it easier and more streamlined for large group to be processed at check-in counters or entry gates.

The entities in a group do not need to be existing contacts in the wallet. For instance, a tour guide can create a group and add his customers for the day to simplify the check-in process at the museum. The group can later be deleted, and none of the former group members are established as a permanent contact of the tour guide.

Creating a Group

Group members can be added through one of many ways:

Selected from the existing wallet contacts;

Using an alias;

Scanning their smart QR code from their wallet; and

Adding them from the phone address book (in case any of the contact info is an alias).

When a member is added to the group, a new temporary alias is created for each member. That temporary alias is then added to the group.

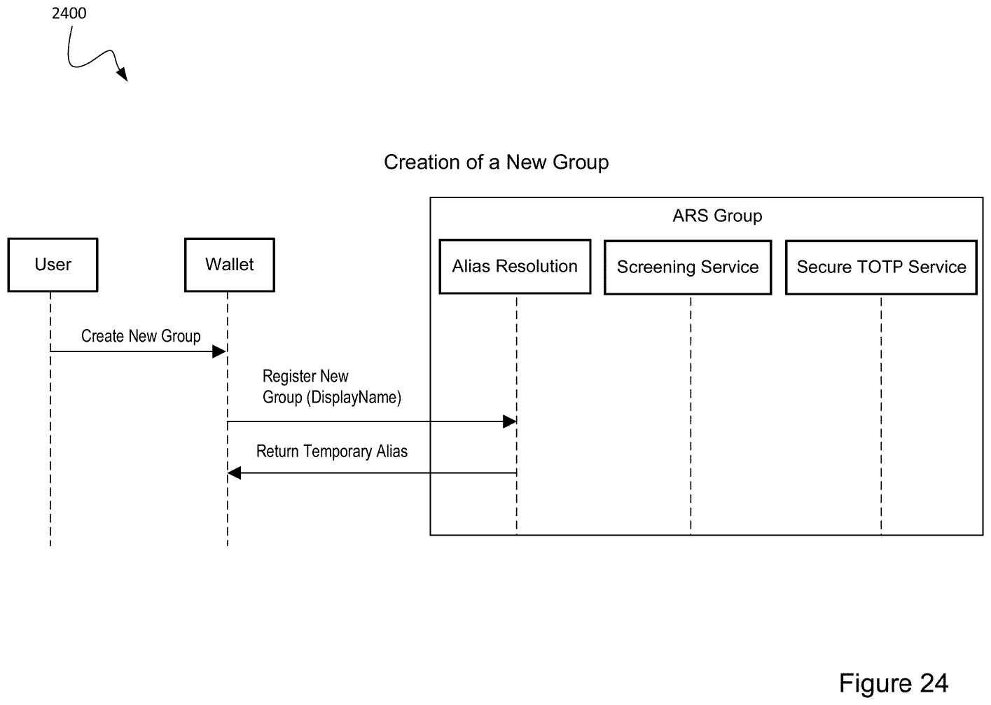

FIG. 24 shows an example process 2400 of how a new group is created. In the Wallet, the group is given a user-friendly name (display name). However, when the group is created, ARS is notified and a new temporary alias associated with the group is created in ARS and is sent back to the wallet.

Adding New Members to a Group

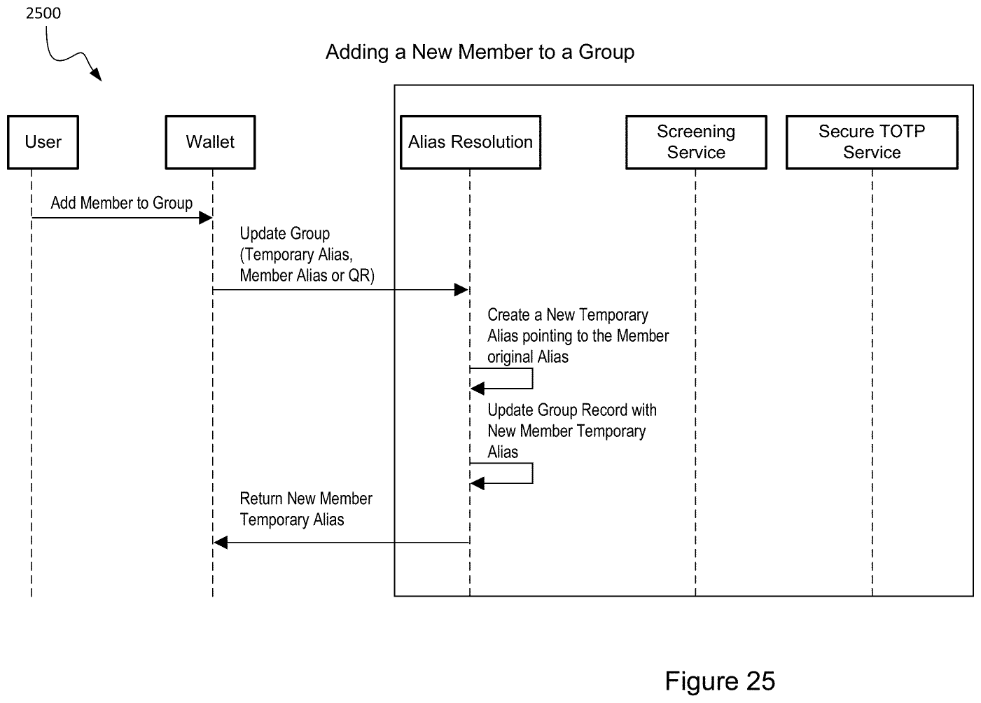

In order to preserve the privacy of the group members, no static aliases or permanent identifiers are stored in the group. Also, unless group members already exist as contact, group members will not be added as such to a wallet. Instead, ARS is contacted for each new member to get a new temporary alias for it, as depicted in the example process 2500 in FIG. 25.

Then, the Temporary Alias is added in ARS to the group and the Wallet is notified to add the corresponding display name of the member in it.

Resolving a Group Alias

Temporary aliases are not permanent and do not compromise the privacy of the actual contact behind it as they require either a PIN or go through a screening service.

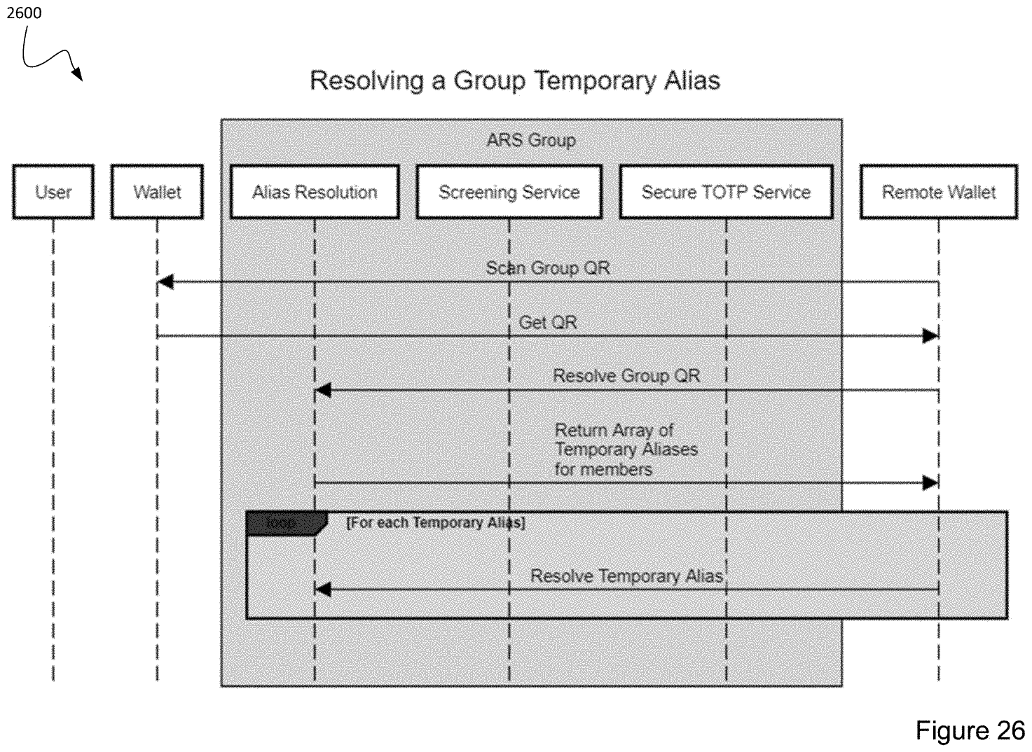

Due to that, when resolving a group alias, as shown in the example process 2600 of FIG. 26, an array of Temporary aliases is returned to the party that is requesting (through a proof request) to resolve the temporary alias.

Once the response (proof response) is receiving the requestor can iterate through the list and proceed with resolving each temporary alias as described earlier. See FIG. 23.

Automatic Processing of Proof Requests

Aliases and paper aliases are meant to facilitate the use of the wallet, and continue to preserve the privacy of its owner. But also, the wallet is meant to reduce the amount of manual work associated with the repeated collection and delivery of information. Therefore, it was imperative to provide mechanisms in the wallet where some level of automation is provided, such as automatically respond to a proof request when using the requestor can be trusted or is already a contact.

This capability would complement features such as the paper aliases or the use of aliases in websites without the need to answer a prompt on the mobile device.

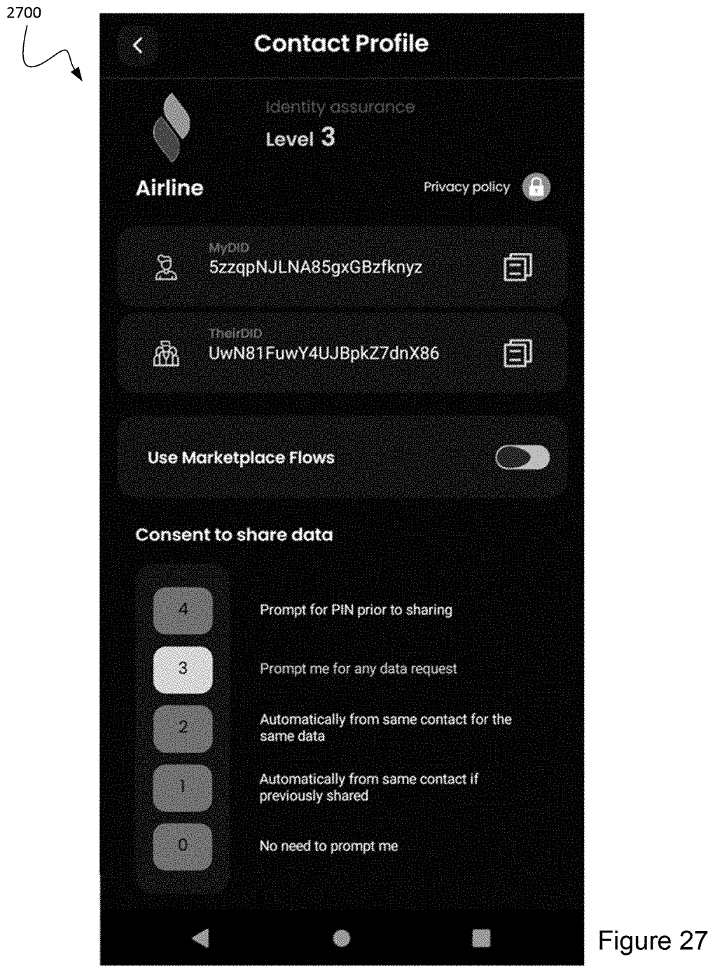

In order to achieve a balance between functionality and security, each contact has a set of auto-consent options which the owner of the wallet can configure. See the example interface 2700 of FIG. 27.

There can be five levels of auto-consent, with the default being level 3 to prompt the Wallet owner for explicit consent for each proof request.

Level 4 would go to a higher level of security also requiring the wallet PIN before processing the proof request.

On the other hand, Level 2 reduces the burden on the owner by allowing proof requests for previously requested data to be automatically sent back without a manual prompt.

Level 1, further lower the manual effort by allowing automatic proof requests to be processed if any previous data was shared with that same contact.

Level 0 would allow the automatic processing of any proof requests from that contact.

URL Shortening Service

SSI and DID QRs tend to hold too much data, and as such they can be dense, requiring the scanning device to hold the camera steady for an extended period of time, and slowing the overall user experience.

To mitigate this issue, Smart QRs can be used to swap the longer URL with shortened ones.

The prefix of a shortened URL would allow the wallet to distinguish a native URL when scanning a QR code from a shortened one.

The prefix also allows a QR code that is scanned with the stock camera app of a smartphone to recognize the association of the QR with the wallet 1200 and therefore launching it automatically.

When a shortened URL is sent to ARS, ARS will automatically process it through the URL shortening service to deflate to its original form. A shortened URL may have an embedded shortened URL. Therefore, the URL shortening service may continue to iteratively resolve the resultant URL till it obtains a native URL.

| [00368] | Prefixes | |
|---|---|---|
| [00369] | Static Alias Prefix: | company://static: |
| [00370] | Group Alias Prefix: | company://group: |
| [00371] | Dynamic Alias | company://dynamic: |
| | Prefix: | |
| [00372] | Temporary Alias | Prefix: company:// |
| | | temporary: |

Verifiable Credentials as Authentication Credentials

As noted, VCs are signed data entities that are issued to a user's wallet by an issuer (business agency) after typically going through an identity vetting process. As part of the issuance process, the VC is signed for authenticity of its source and integrity of its content.

A typical VC such as a digital ID card can therefore be used as a replacement to the legacy username and password.

Unlike a combination of username and password, if digital ID card VC is lost due to the loss of the device, a new one can be requested and reissued allowing the user access back into the protected service.

While any VC can be requested and used as a basis for authentication, special consideration need to be taken into account to avoid introducing weak security gaps into the authentication process where another trusted credential may be used to impersonate the real owner of a digital account.

Issuing an Authentication Verifiable Credential

The process of issuing an authentication VC first requires a digital ID VC. See the following example schema of a Digital ID Card.

```
{
  “attr_names”: [
    “identifier”,
    “dateofissue”,
    “number”,
    “namespace”,
    “category”,
    “_privatehash”,
    “dateofexpiration”,
    “trustlevel”,
    “eyecolors”,
    “ddref”,
    “type”,
    “issuingstatecode”,
    “faceprint”,
    “weight”,
    “surname”,
    “identifier”,
    “countryofissuance”,
    “dateofbirth”,
    “height”,
    “haircolor”,
    “documentclasscode”,
    “documentphoto”,
    “addressline1”,
    “messages”,
    “adressline2”,
    “sex”,
    “restrictions”,
    “icon”,
    “givennames”
  ]
  “name”: “schema.com.company.identitycard”,
  “version”: “1.6”
}
```

Then the digital ID VC is used along with an optional authorization workflow to get the authorization VC which is later also used for Authentication.

Getting a Digital ID Verifiable Credential

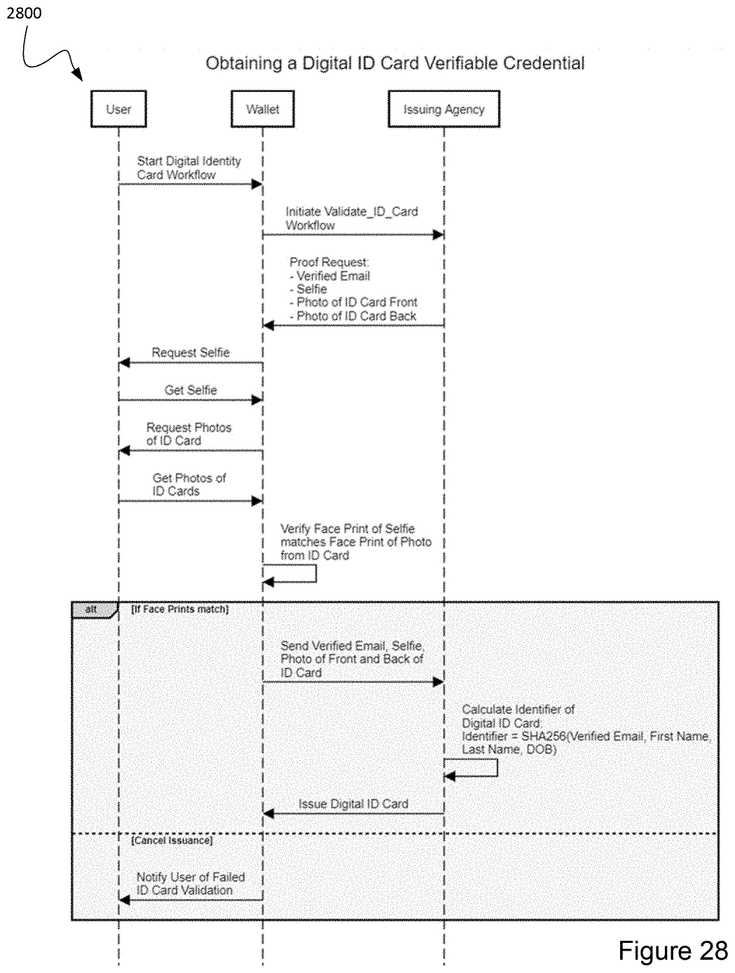

FIG. 28 outlines the example process 2800 of requesting and obtaining a digital ID card VC. Each digital ID card require a unique but deterministic identifier to be computed in order to reestablish ownership of an asset in case the digital ID card is lost or corrupted for any reason. Thus, the identifier when recomputed and verified by a trusted issuing authority can be reused to take ownership of the said asset.

The identifier of Digital Card requires minimization of a collision between any two entities or individuals. Therefore, the identifier needs to be calculated as SHA256 hash of a set of attributes which include First Name, Last Name and DOB. However, in order to avoid having two individuals who happen to have the same name and DOB, the verified email can be used as an additional attribute.

For high security assets, some services may be configured with an elevated security policy which would require a proof of physical presence. This process would require the validation of the presence of the actual individual operating the device. The validation is done by comparing the selfie face print of the individual with the face print of the photo from the digital ID.

Getting an Authorization Verifiable Credential

The following shows the example VC schema of an authorization credential.

```
{
  “attr_names”: [
    “namespace”,
    “type”,
    “identifier”,
    “role”,
    “authorization”,
    “logo”,
    “userid”,
    “validity”,
    “category”,
    “faceprint”,
  ]
  “name”: “schema.com.company.identitycard”,
  “version”: “1.6”
}
```

The inclusion of the identifier attribute within the authorization credential is to tie it to its corresponding Digital ID Card. This way, during authentication, the authenticated service is provided a proof that this credential belongs to the same individual that signed up earlier.

While most of the attribute in the authorization credential schema are optional during authentication.

The namespace is typically required to help filter the specific credential during a proof request.

The type and category are used for managing the credential along with other credentials in the wallet.

The role is used primarily as an authorization attributed to indicate the designated role of the individual.

The userid is a human readable identifier which typically can be an email that would help looking up the user profile in an LDAP directory. However, this attribute is not required when the identifier is provided.

The validity is a logical statement that when calculated results in a binary value (true or false) that indicate if this credential is still valid or not.

The faceprint is requested with a selfie to perform Physical Proof of Presence

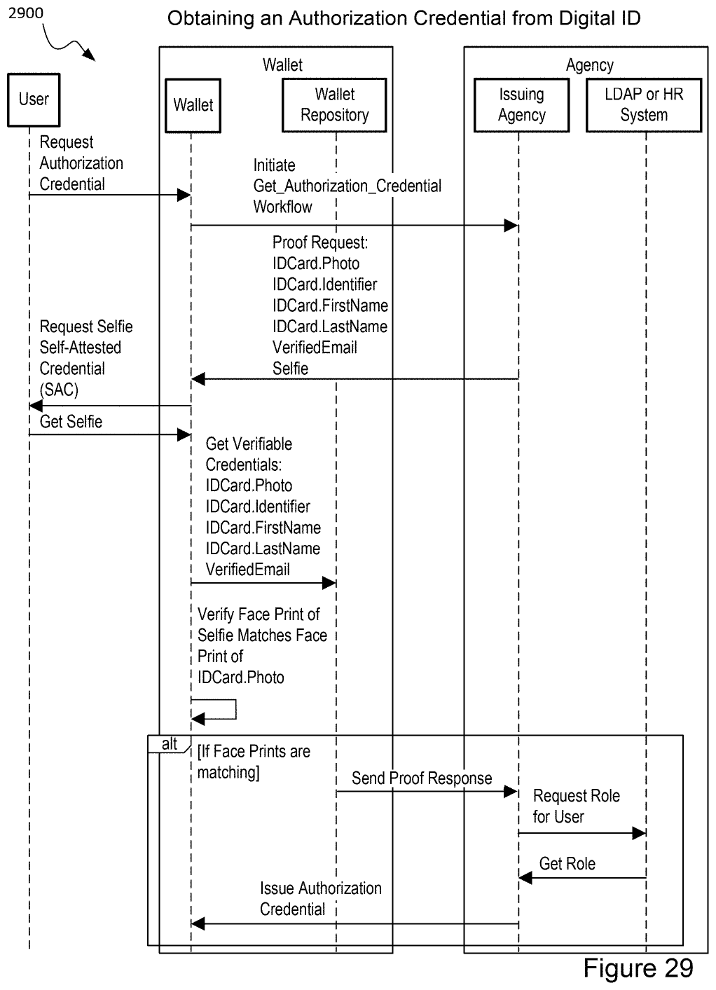

FIG. 29 shows the example process 2900 of obtaining the authorization credential. Again, during this process, if the security policy of a protected asset requires a physical proof of presence, then a selfie is taken and its face print is compared to that of the photo from the digital ID card.

In addition, the Identifier in the digital ID card and the authorization credential would need to be matched before the authorization credential can be trusted and used to authenticate the remote entity.

Authentication Using the Authorization Credential

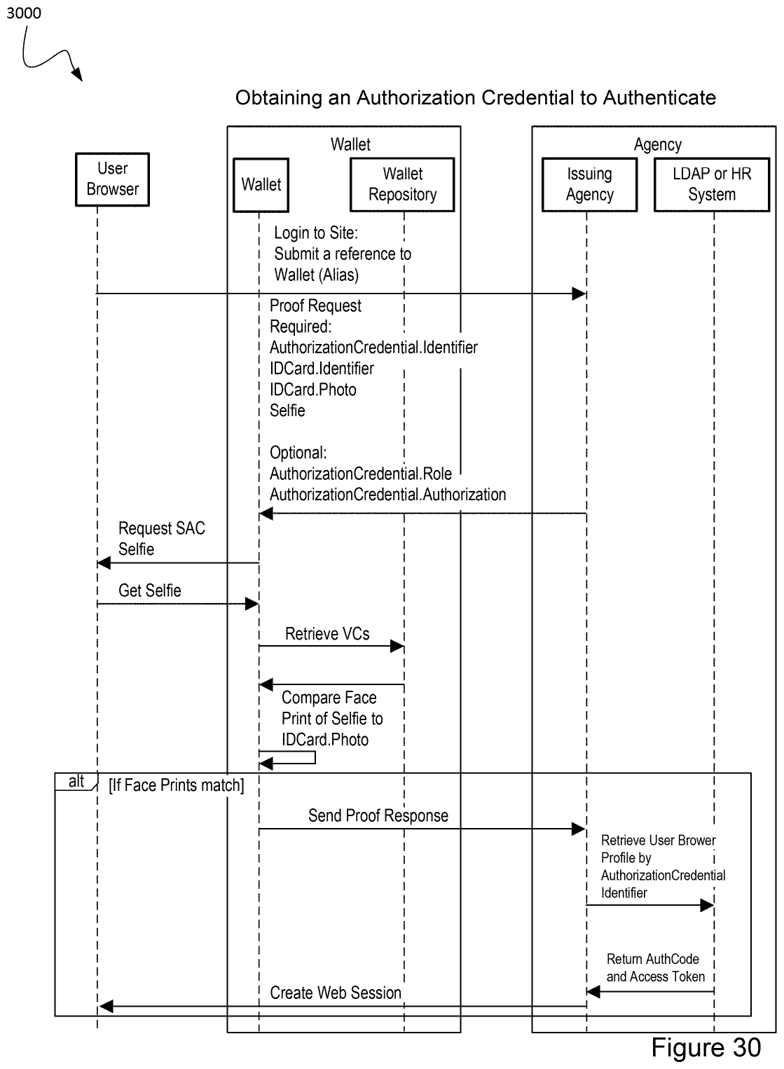

As indicated earlier, once a wallet has obtained an authorization credential, the latter can be used for authenticating, and optionally, getting authorized against a remote service. Also in this process, the use of PPP is driven by the security policy of the protected assets. See FIG. 30 for the example authentication process 3000.

Trust Dependency of Credentials for Verification & Revocation

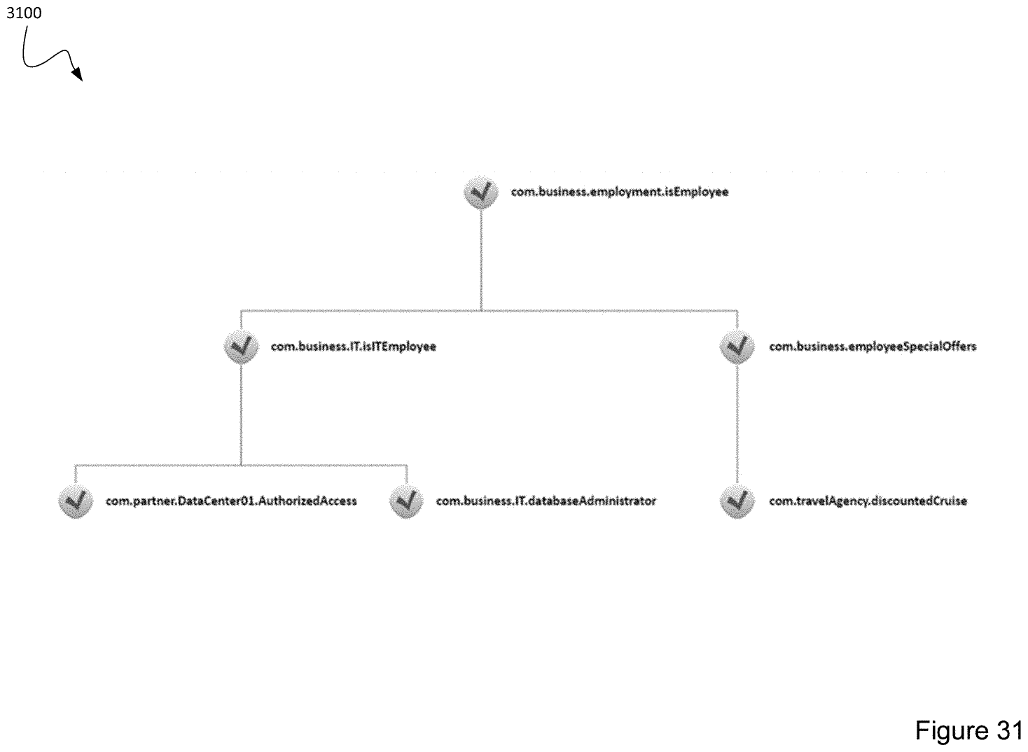

Our system and associated credential schemas hold the special attribute validity that ensures a credential continues to be valid only if its dependencies (one or more) and their predecessors are still in turn valid, therefore virtually creating a dependency tree. FIG. 31 shows an example of a dependency tree 3100 where the VCs at the leaf node levels are all dependent on the validity of the VC at the higher levels.

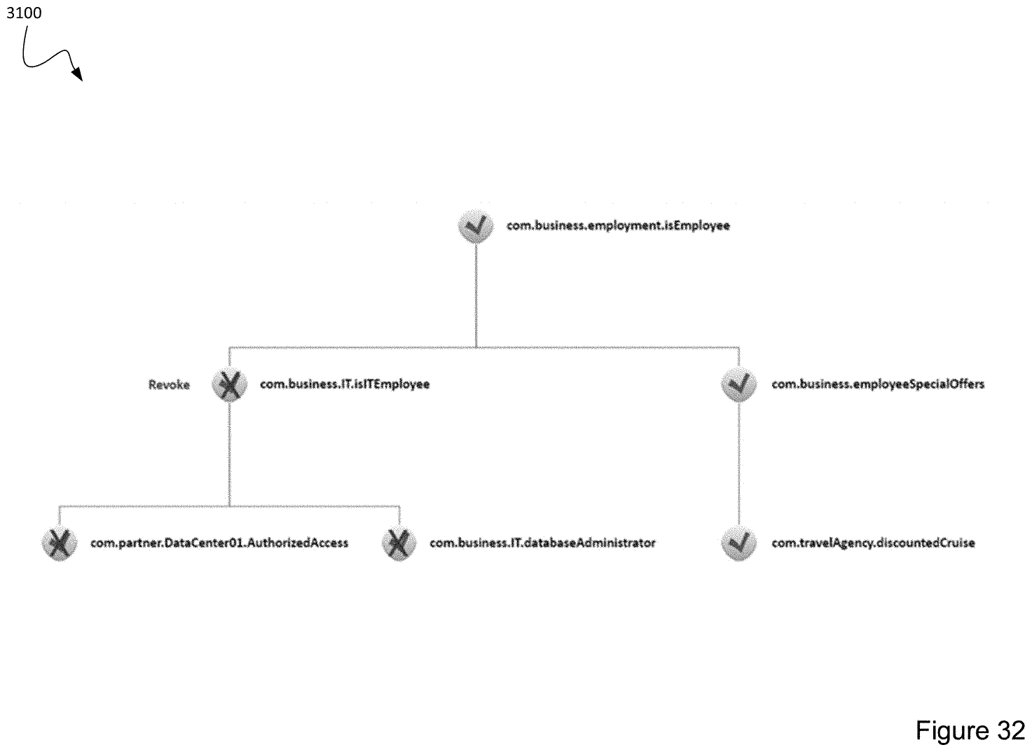

As shown in FIG. 32, the revocation of a credential ‘com.business.IT.isITEmployee’ results in the cascaded revocation of all the credentials that depend on the validity of the former credential for the dependency tree 3100.

This effect is helpful in situations where some IT systems are decentralized and distributed across physical and logical partitions, making it harder to use one access control system across the entire footprint. Data centers and business applications can easily validate the dependency tree of an authorization credential or other VCs to allow or block access to the individuals holding these credentials.

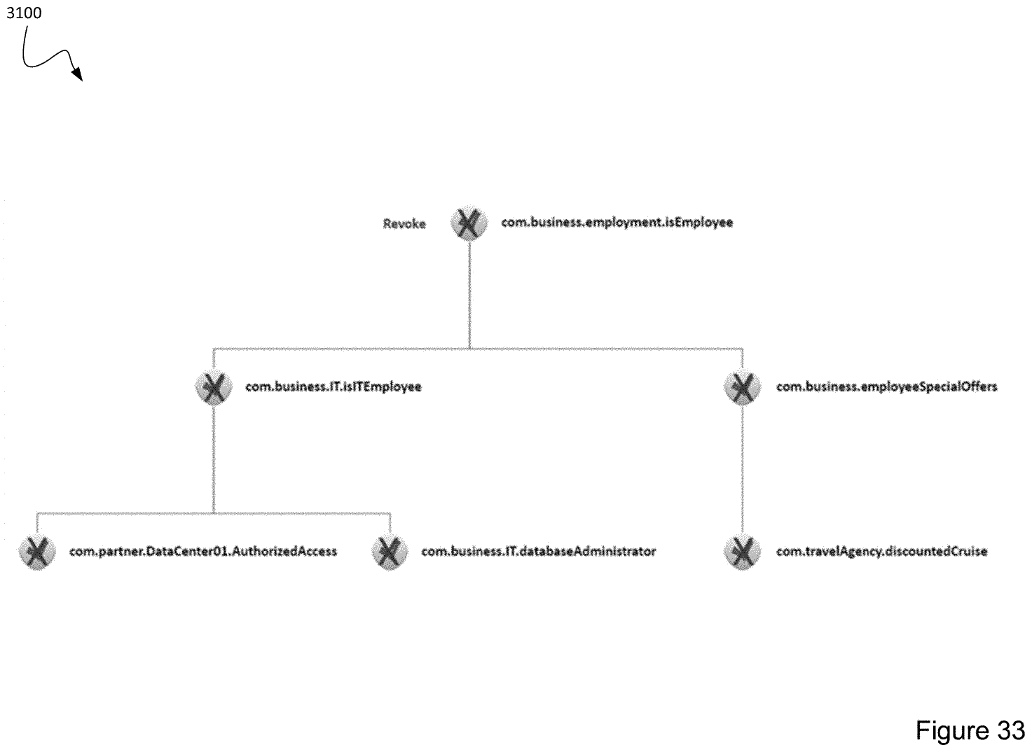

Similarly, in FIG. 33, revoking the top root VC, such as in the case of end of employment of a certain individual, automatically invalidates the credentials in the lower levels of the dependency tree 3100. Thus, blocking access to various decentralized systems without the need to refer to a centralized service.

Reliable Backup and Restore

As observed with various incidents related to crypto wallets, having a user-friendly, yet secure backup and restore methodology can be an important aspect of using a digital wallet.

Often the loss of list of digital mnemonics has resulted in financial losses to the owners of digital wallets as the set of keywords which are generated during the backup of the wallet are very often lost or mismanaged.

Two approaches for securely backing up and restore the digital wallet are disclosed herein. The first one relies purely on information derived from the identity of the wallet owner (something they have) as well as something the owner knows (passphrase). The backed-up wallet can then be stored in a remote location managed by a third party service provider or on a storage repository maintained by the users themselves.

The second method leverages custodial backup and an air gapped system. This provides more flexibility for long term backup and restore, and future access to the owner or their delegates in case the owner is not present, such as in the case of death, to restore the wallet.

Full Autonomous Backup Restore

Backup

Root Key

When a wallet is first created, a public/private cryptographic keypair is created. To avoid losing the private key, it gets stored in the Secure Element (SE) on the device or its SIM card. However, the storage is one-way. The private key is not retrievable which would prevent its backup.

To work around this issue, the root key is also stored temporarily for few days in a secure storage on the device outside the SE. During this time, the digital wallet will continue to remind its owner to complete one full backup. After few days, the root key is purged from the secure storage. If a backup was not done by that time, then it becomes impossible to ever backup the wallet.

Prerequisites

In order to complete a full backup, the owner of the wallet has also to obtain a digital ID card by undergoing identity proofing. Also, the user must have an email and complete its verification.

Wallet Backup

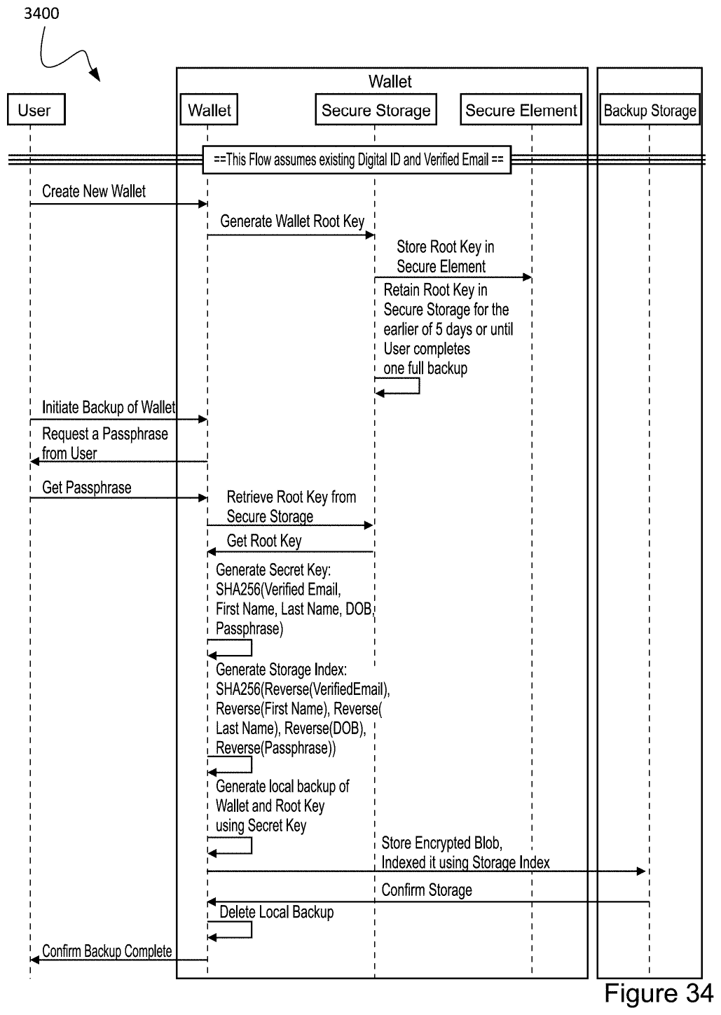

FIG. 34 shows an example process 3400 of creating an autonomous backup. The backup process relies on the availability of an existing digital identity and a verified email which are used to generate the backup secret key.

The restore will require the user to provide the same secret key that is used during backup. Having a secret key that can be reconstructed is very important, in case of its loss for any reason. Therefore, an algorithm is devised that leverage biographic information from a verified digital ID card, and a verified email, along with a passphrase that the user must be able to remember.

This information is used to generate two components:

Secret Key

The secret key is used to encrypt the database of the digital wallet along with the private key. The public key is assumed to have been already shared outside the wallet and therefore it can be easily retrieved.

To generate the secret key, the wallet requests a passphrase from the user. A typical passphrase would be a sentence that the user can easily remember. The passphrase would undergo some transformation such as converting all letters to lower case, and removing any leading and trailing spaces.

Then the wallet would retrieve the following attributes from the digital ID credential: first name, last name and dob. optional photo can also be required, along with the selfie to complete a physical proof of presence during backup and restore.

The wallet also obtains the verified email.

Using the above data, the secret key is generated by calculating the SHA256 hash of the following attribute in this order:

Secret Key=SHA256 (Verified Email, First Name, Last Name, DOB, Passphrase)

Once the secret key is generated the combination of the database of the wallet and root key are encrypted and saved into a local backup file on the device.

The user is given an option for final storage which may include a backup cloud service such as iCloud or G-Drive, a local physical storage such as USB drive, or a managed backup service.

Storage Index

Once the local backup file is generated it needs to be given a unique name which would also help in indexing and retrieving it when sent to a shared backup storage.

The storage index would also need to a deterministic, calculated value. To calculate it using a similar approach, each of the earlier attributes is reversed and a new SHA256 is calculated using the combination of the same attributes:

Storage Index=SHA256 (Reverse (Verified Email), Reverse (First Name), Reverse (Last Name), Reverse (DOB), Reverse (Passphrase))

The storage index is used as a primary key when storing remotely the backup file.

Restore

To restore a backed-up wallet, the user must first provision a temporary wallet and undergo identity proofing to obtain a digital ID VC, and also complete the email verification.

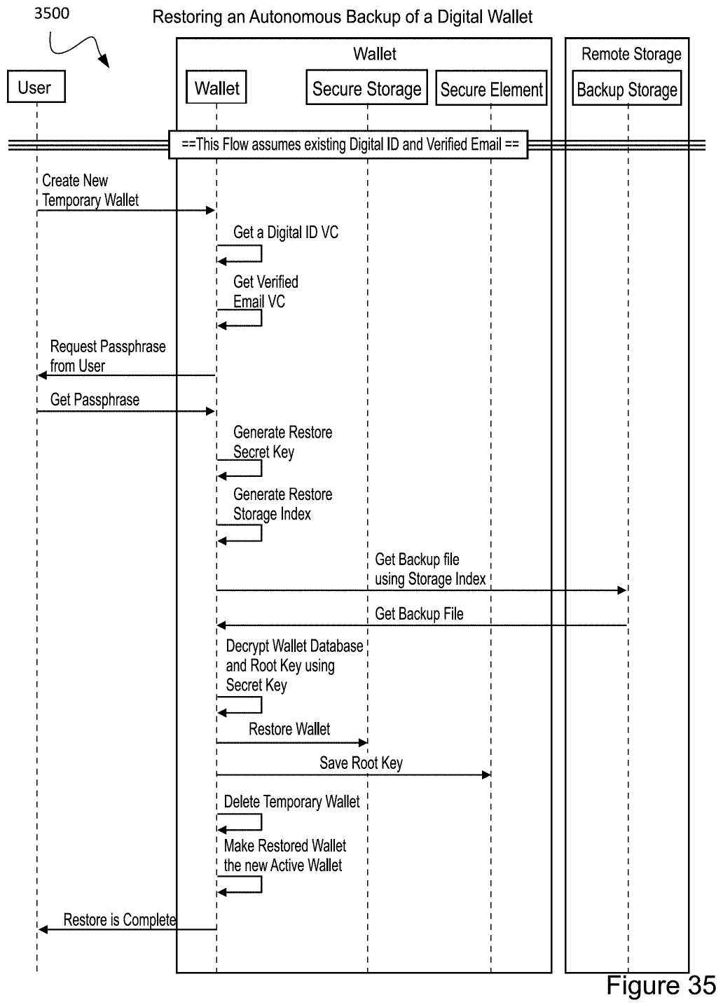

Provided that the user is issued these two credentials, then the example process 3500 is shown in FIG. 35. is basically the reverse of the backup process. Upon restoring the earlier backup, the new temporary wallet is discarded, and the restored wallet is made the active wallet.

Custodial Backup and Restore Using an Air Gapped Service

A major concern about leveraging a backup service provider is how they manage their facility and ensure that any stored encrypted information is not potentially compromised through gap in a process or personal leading to a mass breach of data.

In the case of a digital wallet, secure storage becomes even more challenging as it holds the keys to sensitive information and key services.

While different individuals may prioritize autonomous backup and are not using a managed backup service by a third party, other individuals worry about limited access in the long term to the backup by delegates of the owner. For instance, in the case of death, completing an identity verification (identity proofing) may not be possible. Or not having access to the passphrase means that a digital wallet and all the assets behind it are lost forever.

In this case, having a custodial backup and restore service with all the privacy and security guarantees makes more sense. Restoration of the backup may include an offline process to verify the legal authority or power of attorney on behalf of the original owner to take hold of the digital wallet and its credentials.

Air Gap

To exchange data with the air gap, a method that uses optical exchange of data through the air-gap can ensure that no physical access may result in access to the data through the network or other storage devices such as a USB Key or other storage units.

The transfer of the data through the air-gap uses a small screen on one side displaying information in a sequence of QR codes, and a camera on the other side that reads and interprets it. QR codes are only meant to have one use and that is to represent on side a valid public key, and to represent on the other side an encrypted data blob.

Provided that the algorithm in the air-gapped environment that reads the public key and encrypts data using the public key is not vulnerable to a specially crafted public key that may cause a buffer overrun and inject malicious code in the air-gapped environment, this method would be considered very unlikely to be compromised.

If QRs are too dense to be read on either side, the data is broken into sequenced blocks to work around any size limitation.

Backup

Prerequisites

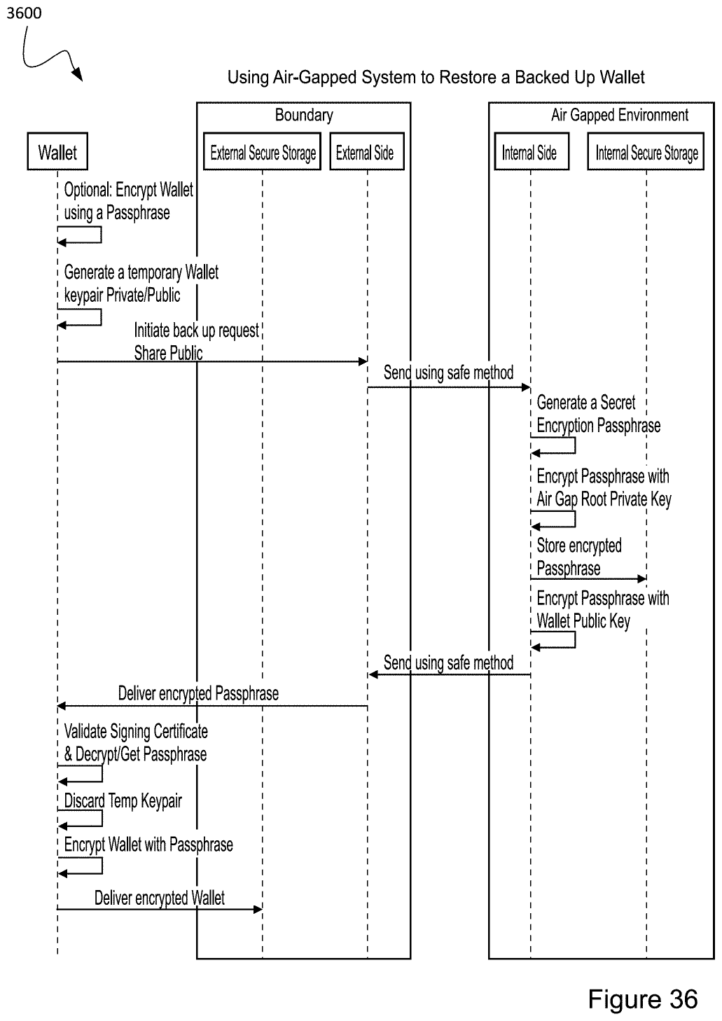

As in the case of the autonomous backup and restore the wallet is expected to contain already a digital ID and a verified email. FIG. 36 describes the example process 3600 of completing the backup by having a passphrase which is used to encrypt the wallet and the root key to be generated and stored on secure storage within the air-gapped facility.

It is also assumed that the air-gapped service has a well-known public key which can be used to validate any data exchanged with it.

Wallet Backup

The following sequence describe how to securely backup the wallet through the air gap. A first optional step may include encrypting the wallet using a passphrase chosen by the user. Although this step provides a good security measure against an unlikely data breach of the air-gapped internal secure storage, it also make it impossible to restore the backup in case the passphrase is lost (death) of forgotten.

It worth to note that only the encrypted passphrase is exchanged with the air-gapped system. The encrypted backup is stored in a remote storage outside the air-gap.

To begin, the Wallet generates a temporary keypair and sends it to the air-gapped environment. Once received at the air-gapped system, a secret passphrase is generated and is encrypted with this public key. That passphrase is also encrypted with the air-gapped service root key and stored in a secure storage within the air-gapped environment.

The passphrase which was encrypted using the wallet temporary public key is sent back through the air-gap to the wallet to complete the generation of the secret key and storage index just like in the case of the autonomous backup/restore.

Once the secret key and storage index are available, the wallet and root key are encrypted, and the local backup file is sent to be stored on the external secure storage.

Wallet Restore

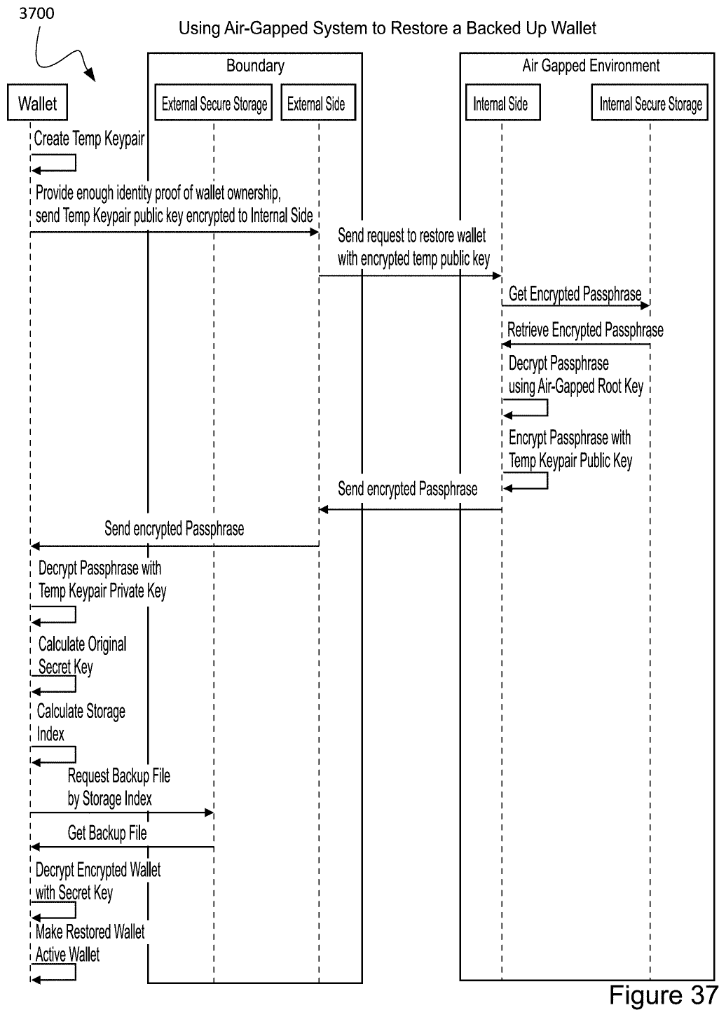

FIG. 37 shows the example process 3700 of restoring a wallet that is backed up using the air-gapped custodial service. A key difference in the restore process as compared to either the restore process of the autonomous restore, or the backup of the custodial is that during restore a different individual may be trying to retrieve the wallet. In this case it may not be possible to perform an identity proofing and therefore the wallet may not have the corresponding digital ID and verified email of the original wallet owner.

An offline process may be required to provide enough evidence in this case, along with information corresponding to the original owner, to the trust service which will act as a proxy to request the passphrase on behalf of the requestor.

The individual requesting the restoration of the backed wallet may provide a power of attorney which may contain enough information to prove relationship to the original owner of the wallet.

Once the passphrase is retrieved from the air-gapped secure storage, it is sent encrypted to the external trust service using the temporary public key generated by the wallet. The trust service then forwards it to the requesting wallet.

In the wallet the original secret key and storage index are calculated using self-attested credential attributes of the first name, last name, dob and verified email of the original wallet owner.

Once the secret key and storage index are calculated, the encrypted wallet is retrieved, restored and made active. This wallet and the current wallet can coexist side-by-side.

Secure and Enhance the Initiation of Phone Calls

As a result of call spoofing and associated phone scams, the telecom industry has implemented a new protocol that digitally signs the header of the SIP protocol when establishing a phone call. This new exchange of signed headers allows the originating and the destination networks to verify the source and destination of the call to the receiver.

While this is a major achievement that will certainly result in reduction of call spoofing, it would still not prevent unsolicited calls from telemarketers who are not hiding away their identities but still flood consumers with calls.

In addition, this technology is the beginning of what could possibly be achieved in terms of automating data exchange as soon as a SIP connection is made.

A digital wallet, running on the device originating the call, may be able to establish a real-time connection with the wireless carrier gateway, providing the possibility of injecting additional metadata in the headers such as an alias, and also to possibly sign the header with the digital wallet unique private key.

The receiver of the call can verify the true identity of the source based on the SSI technology as well as it can issue a proof request to gather additional information prior to answering the call.

This approach can result in significant enhancement to a business process in a contact center.

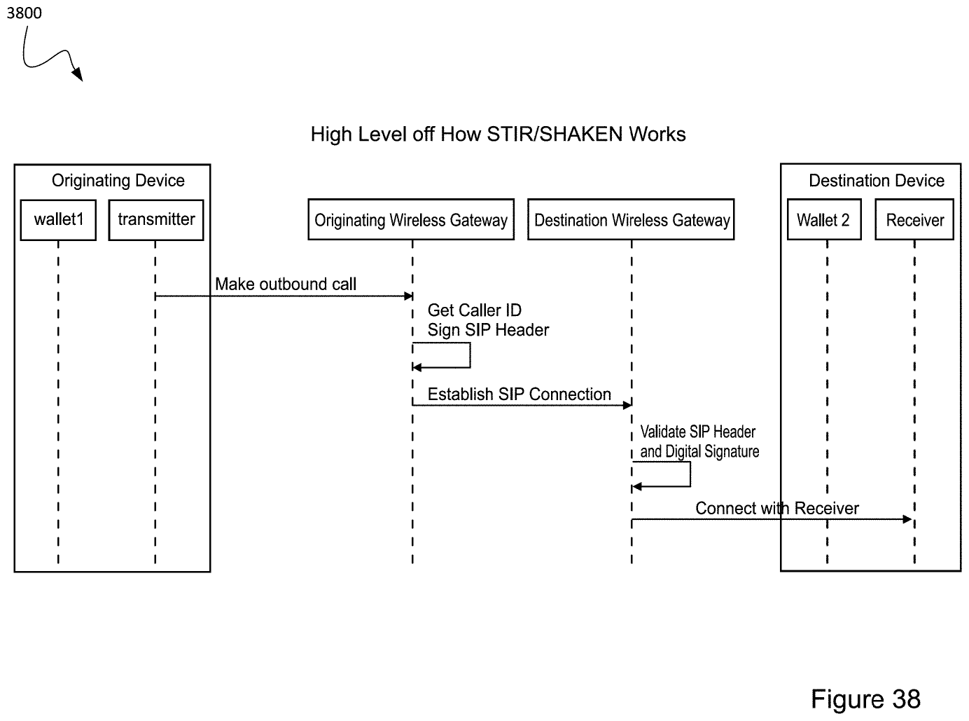

FIG. 38 shows an example high-level flow 3800 of the current STIR/SHAKEN.

Injecting Verified Caller Information

On the Caller Side

As a call is established the wireless gateway would already have the caller ID of the caller as part of the existing STIR/SHAKEN. It is assumed in this case that the caller and its carrier network have already created a DIDComm connection.

The caller ID would be used as an alias for that connection.

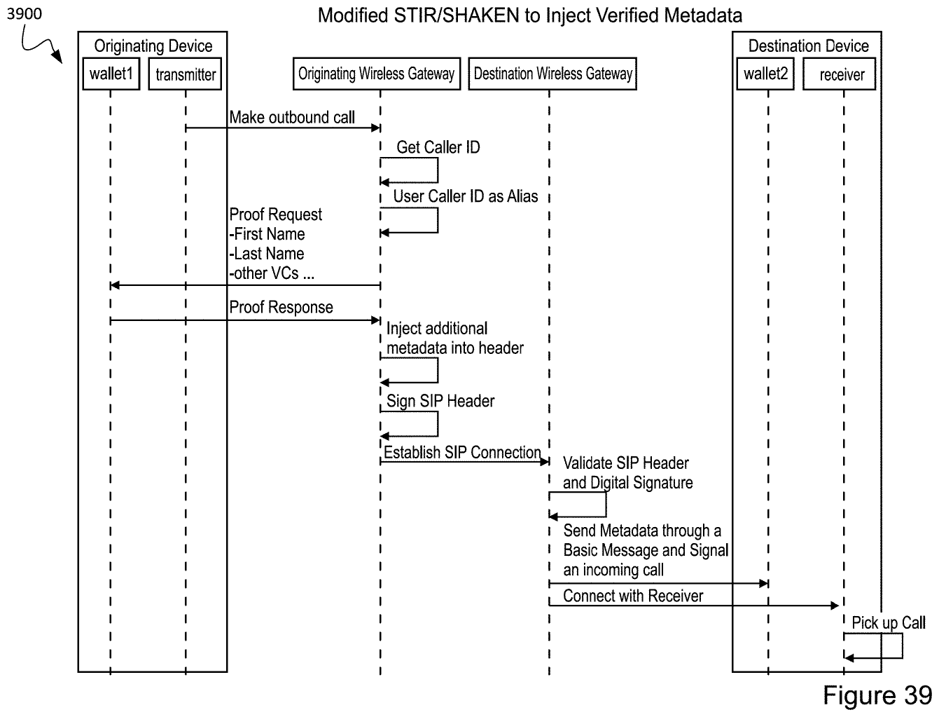

as the caller starts a call, the wireless gateway who is responsible for injecting the sip header and signing it would make a proof request to the wallet of the caller, requesting additional metadata such name, address or other attributes. FIG. 39 shows such an example process 3900.

Once the information is received by the gateway, it is injected along with the Caller ID (or instead of the Caller ID) into the SIP header, and the SIP connection is established.

On the Receiver Side

Assuming the Receiver has already a DIDComm connection with its corresponding telecom network, the phone number will be used as the alias of the receiver's wallet.

When the call is received by the wireless gateway or the POTS, the Gateway would send a basic message (a DIDComm one-way message) with the received header information to the receiver's wallet by resolving the alias to a connection.

The information that is received in the wallet would pop up on the screen before the phone line rings. This would give the receiver the opportunity to screen the call with verified information prior to designing whether to pick up or ignore the call.

Injecting an Alias for Use by the Receiver

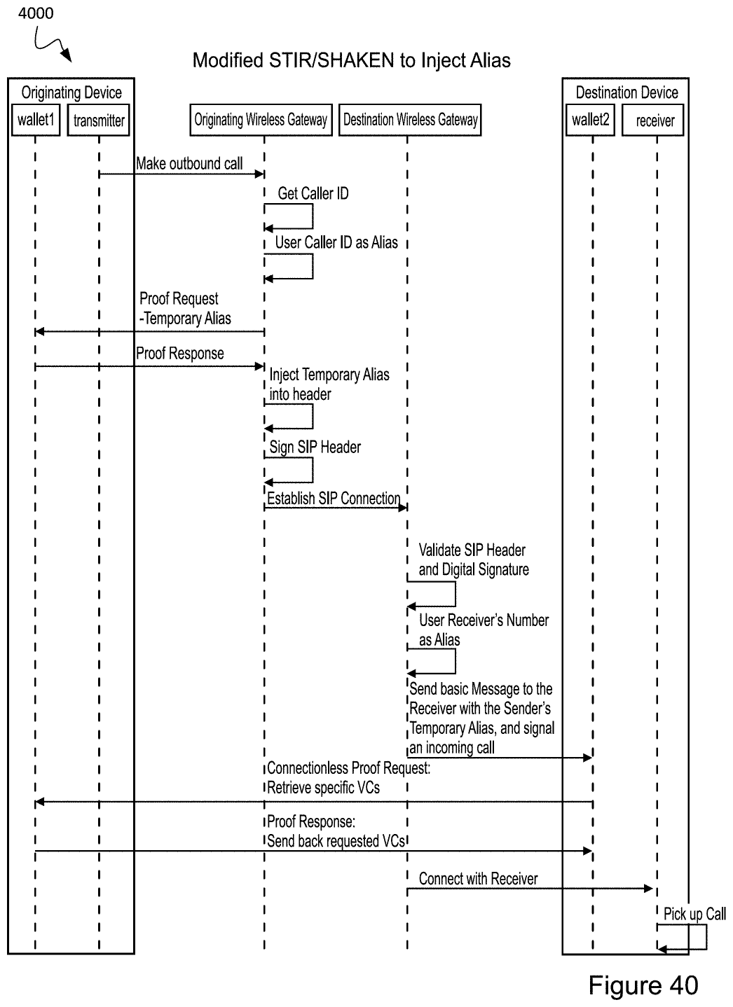

In an alternate process 4000 shown in FIG. 40, the caller's gateway may use the caller id as the caller's wallet alias. The caller gateway may send a proof request to the caller wallet requesting a temporary alias.

Once received, the temporary alias is injected into the SIP header to be delivered to the receiver.

Just as in the previous case, the receiver may receive the temporary alias through wallet and prior to establishing the call. The wallet can be instructed to make a request for specific attributes which allows it to screen the caller or to automate a process for handling incoming calls such as in contact centers.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A system, comprising:
at least one processor; and
non-transitory computer-readable storage storing instructions that, when executed by the at least one processor, cause the system to:
provide a workflow to add a verifiable credential on a client device, the workflow generating the verifiable credential according to parameters defined by an entity associated with the verifiable credential;
populate the verifiable credential in a wallet on the client device, the wallet; and
surface the verifiable credential from within the wallet when a request for the verifiable credential is received.

2. The system of claim 1, wherein the workflow is programmed to be performed within the wallet on the client device.

3. The system of claim 1, comprising further instructions that, when executed by the at least one processor, cause the system to revoke the verifiable credential according to a dependency tree.

4. The system of claim 1, comprising further instructions that, when executed by the at least one processor, cause the system to define the verifiable credential as a zero knowledge proofs configured to provide a binary answer to the request for the verifiable credential.

5. The system of claim 1, comprising further instructions that, when executed by the at least one processor, cause the system to confirm a revocation status of the verifiable credential within a distributed ledger.

6. The system of claim 1, comprising further instructions that, when executed by the at least one processor, cause the system to generate an alias referring to the wallet, the alias being a user-friendly name.

7. The system of claim 6, wherein the alias is either: a static alias having a long lifespan; or a dynamic alias having a short lifespan.

8. The system of claim 6, comprising further instructions that, when executed by the at least one processor, cause the system to provide an alias resolution service programmed to resolve the alias to the wallet.

9. The system of claim 1, comprising further instructions that, when executed by the at least one processor, cause the system to provide an authentication credential workflow that is programmed to convert the verifiable credential into an authentication credential wherein the authentication credential is configured to authenticate an owner of the wallet.

10. The system of claim 9, wherein the authentication credential comprises a deterministic identifier that is computable to establish ownership of the authentication credential.

11. The system of claim 1, comprising further instructions that, when executed by the at least one processor, cause the system to:
create a group referring to a plurality of aliases; and
allow workflows to be initiated simultaneously in multiple wallets when interacting with the group.

12. The system of claim 1, comprising further instructions that, when executed by the at least one processor, cause the system to create a backup of the wallet.

13. The system of claim 12, wherein the backup is created through one of encryption or custodial services.

14. The system of claim 1, comprising further instructions that, when executed by the at least one processor, cause the system to inject an alias associated with the verifiable credential into a header of a telephone call.

15. The system of claim 14, further comprising using the alias as a caller identification for the telephone call.

16. A system, comprising:
at least one processor; and
non-transitory computer-readable storage storing instructions that, when executed by the at least one processor, cause the system to:
provide a workflow to add a verifiable credential to a client device, the workflow generating the verifiable credential according to parameters defined by an entity associated with the verifiable credential;
populate the verifiable credential in a wallet on the client device, the wallet;
surface the verifiable credential from within the wallet when a request for the verifiable credential is received;
define the verifiable credential as a zero knowledge proofs configured to provide a binary answer to the request for the verifiable credential;
tie a faceprint of an owner of the wallet to the verifiable credential in the wallet; and
generate an alias referring to the wallet, the alias being a user-friendly name, wherein the alias is either: a static alias having a long lifespan; or a dynamic alias having a short lifespan.

17. The system of claim 16, comprising further instructions that, when executed by the at least one processor, cause the system to allow the verifiable credential to react to an external stimulus, wherein the external stimulus includes one or more of location and time.

18. The system of claim 16, comprising further instructions that, when executed by the at least one processor, cause the system to provide an authentication credential workflow that is programmed to convert the verifiable credential into an authentication credential.

19. A method, comprising:
providing a workflow to add a verifiable credential on a client device, the workflow generating the verifiable credential according to parameters defined by an entity associated with the verifiable credential;
populating the verifiable credential in a wallet on the client device, the wallet; and
surfacing the verifiable credential from within the wallet when a request for the verifiable credential is received.

20. The method of claim 19, further comprising comparing the verifiable credential to a revocation list on a blockchain to determine a revocation status of the verifiable credential.
